(19) United States
(12) Patent Application Publication
(10) Pub. No.: US 2026/0276818 A1
(43) Pub. Date: Sep. 17, 2026

(54) MULTI-MODE LASER MEASUREMENT DEVICE AND LASER DISTANCE MEASUREMENT METHOD

(71) Applicant: Shenzhen Mileseey Technology Co., Ltd., Shenzhen (CN)

(72) Inventors: Long LUO, Shenzhen (CN); Zhi CHOU, Shenzhen (CN)

(73) Assignee: Shenzhen Mileseey Technology Co., Ltd., Shenzhen (CN)

(21) Appl. No.: 19/682,324

(22) Filed: May 19, 2026

Related U.S. Application Data
(63) Continuation of application No. PCT/CN2024/135541, filed on Nov. 29, 2024.

(30) Foreign Application Priority Data
Jan. 20, 2024 (CN) 202420145690.9
Jan. 20, 2024 (CN) 202420147099.7
Jan. 20, 2024 (CN) 202420153502.7
Jan. 22, 2024 (CN) 202410086264.7

(51) Int. Cl. G01S 17/10; G01S 7/481; G01S 7/51

(52) U.S. Cl. CPC G01S 17/10; G01S 7/4813; G01S 7/4815; G01S 7/51

(57) ABSTRACT

Provided is a multi-mode laser measurement device. A first emitter in the laser measurement assembly is configured to emit a first emitted laser beam having a first wavelength to a target object, where the first emitted laser beam is reflected by the target object into a first reflected laser beam. A second emitter is configured to emit a second emitted laser beam having a second wavelength to the target object, where the second emitted laser beam is reflected by the target object into a second reflected laser beam which is different from the first wavelength. A receiving module is configured to receive a reflected laser beam, where the reflected laser beam includes the first reflected laser beam and/or the second reflected laser beam. A photosensitive element in the receiving module can detect laser light of the first wavelength and the second wavelength during operation.

### RELATED APPLICATIONS

This application is a continuation application of PCT application No. PCT/CN2024/135541, filed on Nov. 29, 2024, which claims the benefit of priority to Chinese Patent Application No. 202420145690.9, 202420147099.7, and 202420153502.7, filed on Jan. 20, 2024, and to Chinese Patent Application No. 202410086264.7, filed on Jan. 22, 2024, the entire contents of the foregoing documents are incorporated herein by reference.

### TECHNICAL FIELD

The present disclosure relates to the technical field of measurement, and in particular, to a multi-mode laser measurement device and a multi-mode laser distance measurement method.

### BACKGROUND

With the rapid development of laser detection technology, it has also been widely used for distance measurement. Range finders employing the laser detection technology are now used by users in many scenarios to measure distances. Users have different distance measurement requirements in different scenarios. For example, a user may require a long distance measurement. A long distance means that the distance between a range finder and a target point may be several kilometers. For another example, a user may require a short distance measurement. A short distance means that the distance between a range finder and a target point may be several meters to tens of meters.

Compared with the long distance measurement, users have higher requirements for distance measurement accuracy when performing short distance measurement. Since the laser wavelengths used for the short distance measurement and the long distance measurement are different, a laser measurement device integrated with both short distance measurement and long distance measurement functions typically requires two receivers to respectively receive laser light corresponding to two modules. The two receivers occupy a large space inside the range finder, resulting in too large overall size of the range finder and inconvenience for users to use.

### BRIEF SUMMARY

In a first aspect, the present application provides a multi-mode laser measurement device using only a single photosensitive element. According to an embodiment of the present application, the laser measurement device includes a first emitting module, a second emitting module, and a receiving module. The first emitting module includes a first emitter configured to emit a first emitted laser beam having a first wavelength to a target object during operation, where the first emitted laser beam is reflected by the target object into a first reflected laser beam. The second emitting module includes a second emitter configured to emit a second emitted laser beam having a second wavelength to the target object during operation, where the second emitted laser beam is reflected by the target object into a second reflected laser beam, and the second wavelength is different from the first wavelength. The receiving module is configured to, during operation, receive a reflected laser beam and measure a target distance between the laser measurement device and the target object based on the reflected laser beam, where the reflected laser beam includes the first reflected laser beam and/or the second reflected laser beam. The receiving module includes a photosensitive element configured to detect laser light of the first wavelength and the second wavelength during operation.

In a second aspect, the present application provides a multi-mode laser distance measurement method, applied to the laser measurement device according to the first aspect. The distance measurement method includes: activating a second emitting module of the laser measurement device to emit a second emitted laser beam and a receiving module to receive a second reflected laser beam reflected back by a target object; obtaining a second distance based on the second reflected laser beam; and determining, based on the second reflected laser beam and the second distance, whether operation in a plurality of modes is activated, where in the plurality of modes, the laser measurement device activates a first emitting module to emit a first emitted laser beam and the receiving module to receive a first reflected laser beam reflected back by the target object; obtaining a first distance based on the first reflected laser beam; and determining and outputting a target distance based on the first distance and the second distance.

In a third aspect, the present application provides another multi-mode laser distance measurement method, applied to the laser measurement device according to the first aspect. The laser distance measurement method includes: obtaining a selected mode input by a user, where the selected mode is a first mode in which a first emitting module emits a first emitted laser beam or a second mode in which a second emitting module emits a second emitted laser beam; measuring a target distance between the laser measurement device and a target object based on the selected mode; and outputting the target distance.

In conclusion, this specification provides a multi-mode laser measurement device using a single photosensitive element. The measurement device can achieve integrated high-accuracy short distance measurement and long distance measurement by emitting the first emitted laser beam and the second emitted laser beam, thereby meeting various measurement requirements of users. Moreover, both the first wavelength of the first emitted laser beam and the second wavelength of the second emitted laser beam fall within the sensing band of the single photosensitive element. Thus, by providing the single photosensitive element, the receiving module can simultaneously receive the first reflected laser beam and the second reflected laser beam during operation, thereby reducing the space occupied by distance measurement components within the measurement device.

Other functions of the multi-mode laser measurement device and laser distance measurement method provided herein will be enumerated in part in the following description. According to the description, the contents presented by reference numerals and examples will be apparent for those of ordinary skill in the art. Creative aspects of the multi-mode laser measurement device and laser distance measurement method provided herein may be fully explained by practice or by using the methods, devices, and combinations described in the following detailed examples.

### BRIEF DESCRIPTION OF THE DRAWINGS

To describe the technical solutions in the embodiments of this specification more clearly, the accompanying drawings required for describing the embodiments are briefly described below. Apparently, the accompanying drawings in the following description show merely some embodiments of this specification, and a person of ordinary skill in the art may derive other drawings from these accompanying drawings without creative efforts.

FIG. 1 illustrates a schematic diagram of an appearance and a structure of a multi-mode laser measurement device according to some embodiments of this specification;

FIG. 2 illustrates a diagram of an internal optical structure of a measurement device according to some embodiments of this specification;

FIG. 3 illustrates details of a laser measurement assembly in the optical structure;

FIG. 4 illustrates a diagram of internal optical paths of a beam splitting module of a measurement device according to some embodiments of this specification;

FIG. 5 illustrates a diagram of another measuring optical path and viewing optical path according to some embodiments of this specification;

FIG. 6 illustrates a structural schematic diagram of a laser measurement device with a dual-display module according to some embodiments of this specification;

FIG. 7 illustrates a flowchart of a laser distance measurement method according to some embodiments of this specification;

FIG. 8 illustrates a flowchart of another laser distance measurement method according to some embodiments of this specification;

FIG. 9 illustrates a structural schematic diagram of a measurement device according to some embodiments of this specification;

FIG. 10 illustrates an exploded structural schematic diagram of a laser measurement device according to some embodiments of this specification;

FIG. 11 illustrates a structural schematic diagram of a second end of an inner housing and an eyepiece group according to some embodiments of this specification;

FIG. 12 illustrates a structural schematic diagram of an adjusting knob according to some embodiments of this specification;

FIG. 13 illustrates a structural schematic diagram of an inner housing, an eyepiece group, and an adjusting knob that are connected according to some embodiments of this specification;

FIG. 14 illustrates a front view of a laser measurement device according to some embodiments of this specification;

FIG. 15 illustrates a sectional view of FIG. 14 taken along section B-B;

FIG. 16A illustrates a structural schematic diagram of a measurement device having a first magnetic assembly mounted thereon according to some embodiments of this specification;

FIG. 16B illustrates a structural schematic diagram of a laser measurement device having an auxiliary shell mounted on a bottom thereof according to some embodiments of this specification;

FIG. 17A illustrates a structural schematic diagram of a measurement device having magnetic assemblies mounted on a bottom and a side thereof according to some embodiments of this specification;

FIG. 17B illustrates a structural schematic diagram of a measurement device having auxiliary shells mounted on a bottom and a side thereof according to some embodiments of this specification;

FIG. 18 illustrates an exploded view of a laser measurement device according to some embodiments of this specification;

FIG. 19 illustrates a rear view of a switch key and an exit end cap that are connected according to some embodiments of this specification;

FIG. 20 illustrates a sectional view A-A of FIG. 19;

FIG. 21A illustrates a front view of a measurement device in an operating state according to some embodiments of this specification;

FIG. 21B illustrates a left view of a measurement device in an operating state according to some embodiments of this specification;

FIG. 21C illustrates a right view of a measurement device in an operating state according to some embodiments of this specification;

FIG. 21D illustrates a top view of a measurement device in an operating state according to some embodiments of this specification;

FIG. 22A illustrates an exploded view of a laser measurement device according to some embodiments of this specification;

FIG. 22B illustrates a right view of a laser measurement device in an operating state with a switch key in a first position according to some embodiments of this specification;

FIG. 23 illustrates a rear view of a switch key 620b according to some embodiments of this specification; and

FIG. 24 illustrates a top view of a self-locking mechanism according to some embodiments of this specification.

### DETAILED DESCRIPTION OF THE DRAWINGS AND THE PRESENTLY PREFERRED EMBODIMENTS

The following description provides specific application scenarios and requirements of this specification, with the purpose of enabling those skilled in the art to make and use the content in this specification. For those skilled in the art, various partial modifications to the disclosed embodiments are obvious, and without departing from the spirit and scope of this specification, the general principles defined herein can be applied to other embodiments and application. Therefore, the specification is not limited to the embodiments, but is consistent with the widest scope of claims.

It should be understood that the terms “comprise” and “include” used in the specification and claims of the present disclosure indicate the presence of described features, integers, steps, operations, elements and/or components, but do not exclude the presence or addition of one or more of other features, integers, steps, operations, elements, components, and/or sets thereof.

It should also be understood that the terms used in the specification of the present disclosure are for the purpose of describing specific embodiments only and are not intended to limit the present disclosure. As used in the specification and claims of the present disclosure, the singular forms “a”, “an”, and “the” are intended to include the plural forms unless the context clearly indicates otherwise.

It should also be further understood that the term “and/or” used in the specification and claims of the present disclosure refers to one or any or all possible combinations of a plurality of associated items that are listed, and includes these combinations. In this specification, the expression “A, B and/or C” has the same meaning as that expressed by “X includes at least one of A, B, or C”, both indicating that X includes at least A, or X includes at least B, or X includes at least C. In other words, X includes any one of A, B, and C, or includes any combination of A, B, and C, and other possible content/elements. The any combination of A, B, and C is A, B, C, AB, AC, BC, or ABC.

In this specification, unless explicitly stated otherwise, an association relationship between structures is either a direct association relationship or an indirect association relationship, as well as either a total association relationship or a partial association relationship. For example, for the description “A is connected to B”, unless it is explicitly described that A is directly connected to B, it will be construed as A being directly connected to B or indirectly connected to B. For another example, for the description “A is over B”, unless it is explicitly described that A is directly above B (A and B are adjacent and A is above B), it will be construed as A being directly above B, or A is indirectly over B (A and B are spaced apart by another element and A is above B). For another example, when describing “A is inside B”, unless it is explicitly stated that A is entirely inside B, it should be understood that A is entirely inside B, or A is partially inside B, and so on.

As used in this specification and the claims, the term “if” can be interpreted as “when” or “once” or “in response to a determination” or “in response to a detection” according to the context. Similarly, the phrase “if [the described condition or event] is determined” or “if [the described condition or event] is detected” can be interpreted as “once [the described condition or event] is determined” or “in response to the determination of [the described condition or event]” or “once [the described condition or event] is detected” or “in response to the detection of [the described condition or event]” according to the context.

In consideration of the following description, in this specification, these and other features, the operations and functions of related elements of the structure, as well as the economic efficiency of the combination and manufacturing of components can be significantly improved. The description also includes figures and texts with reference to the figures in this specification, all of which form part of this specification. However, it should be clearly understood that the drawings are merely intended for illustration and description purposes, rather than to limit the scope of this specification. It should be understood that the accompanying drawings are not drawn to scale.

The present application provides a multi-mode laser measurement device using a single photosensitive element. The multi-mode laser measurement device can not only meet users' measurement requirements for different distances but also reduce the space occupied by distance measurement assemblies within the laser measurement device.

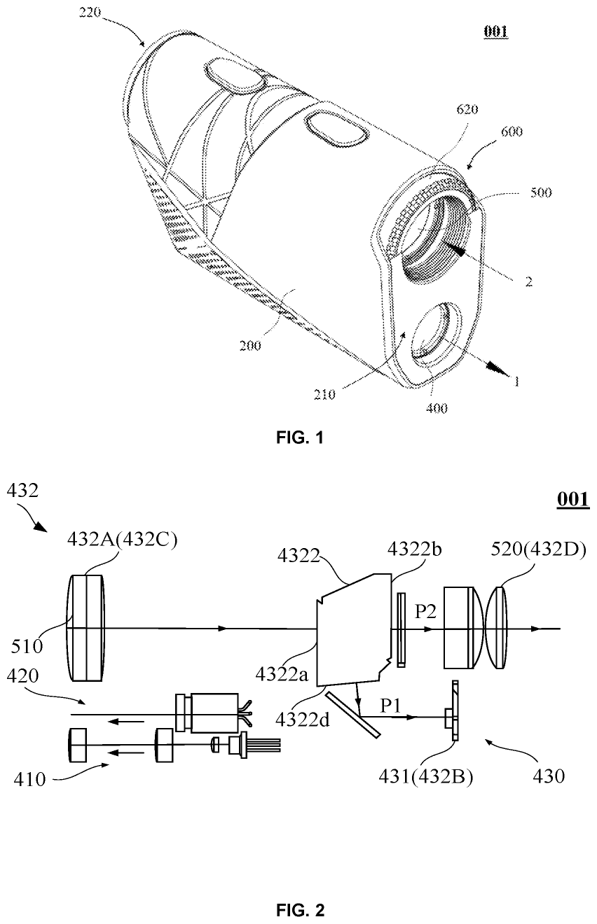

FIG. 1 illustrates a schematic diagram of an appearance and a structure of a multi-mode laser measurement device 001 according to some embodiments of this specification.

The multi-mode laser measurement device 001 (hereinafter referred to as laser measurement device 001 or measurement device 001) may be a small hand-held measurement device 001 shown in FIG. 1. For example, the measurement device 001 can be used in golf. Golf is a sport and recreational activity played on outdoor lawns, in which players use different clubs and follow certain rules to hit a ball into designated holes. When playing golf, users often need to use the measurement device 001 to measure the distance to a target object such as a hole. Since a golf course is large, users usually need long-distance measurement before hitting the ball onto the green. After the ball is on the green, users further use a putter to roll the ball into the hole. At this time, the distance between the ball and the hole has been greatly shortened, and therefore, users will use short distance measurement. In this case, users have higher requirements for short distance measurement accuracy, thereby ensuring that they can accurately putt the ball into the hole. Such a measurement device 001 for golf also needs to be compact, lightweight, and easy to carry.

As shown in FIG. 1, the measurement device 001 may include a housing 200 and a laser measurement assembly 400 (hereinafter referred to as measurement assembly 400).

In some embodiments, the measurement device 001 may further include a telescope assembly 500. In some embodiments, the measurement device 001 may further include a switch assembly 600. In some embodiments, the measurement device 001 may further include a diopter switch. In some embodiments, the measurement device 001 may further include a first magnetic attraction assembly.

The housing 200 may serve as a mounting base of the measurement device 001.

Other components (such as a measurement assembly 400, the telescope assembly 500, and the switch assembly 600) of the measurement device 001 may be mounted in the housing 200 as a carrier. The shape of the housing 200 may be any shape to accommodate the mounting of other components. The shape of the housing 200 may be an ergonomic shape to facilitate user operation. The material of the housing 200 may be any material, such as metals, plastics, polymers, and rubber. This specification does not limit the shape and material of the housing 200. The housing 200 may include a first end 210 and a second end 220. The first end 210 and the second end 220 may be ends of the housing 200, respectively. For example, the first end 210 and the second end 220 may be two ends of the housing 200 distributed along a laser emission direction. The first end 210 may be a laser exit end of the measurement device 001. The second end 220 may be disposed opposite the first end 210.

The measurement assembly 400 may be configured for distance measurement. In some embodiments, in addition to distance measurement, the measurement assembly 400 may be further configured for slope measurement. The measurement assembly 400 may be mounted within the housing 200. When the measurement assembly 400 performs distance measurement, the measurement assembly 400 may emit laser light to the outside of the housing 200. The laser light is reflected back after encountering a target object, and the laser light reflected by the target object is received by the measurement assembly 400.

The measurement assembly 400 determines the distance between the target object and the measurement assembly 400 by comparing the emitted laser light with the received laser light. Arrow 1 shown in FIG. 1 may indicate the emission direction of the laser light, and arrow 2 may indicate the receiving direction of the laser.

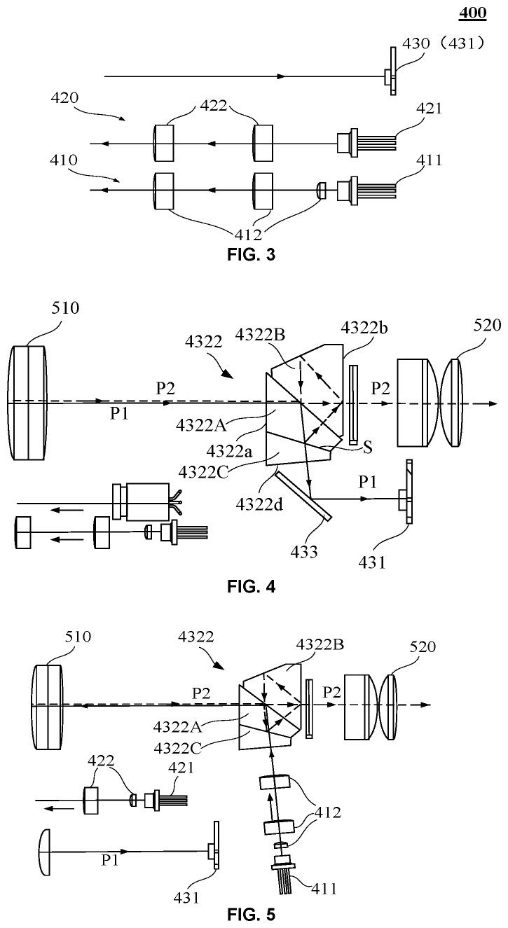

FIG. 2 illustrates a diagram of an internal optical structure of a measurement device 001 according to some embodiments of this specification. FIG. 3 illustrates details of a measurement assembly 400 in the structure. The measurement assembly 400 includes a first emitting module 410, a second emitting module 420, and a receiving module 430.

The first emitting module 410 includes a first emitter 411. The first emitter 411 is configured to emit a first emitted laser beam having a first wavelength to a target object during operation. The target object may be an object of which distance from the user the user wishes to obtain. For example, on a golf course, the target object may be a flagstick inserted in the center of a hole to indicate the hole's position, etc. For instance, the first emitter 411 may be a laser diode capable of emitting laser light of the first wavelength. The first emitted laser beam is reflected by the target object into a first reflected laser beam. In some embodiments, the first emitting module 410 further includes a first lens group 412. The first emitted laser beam passes through the first lens group 412 and then is incident on the target object. The first lens group 412 can collimate the first emitted laser beam such that the first emitted laser beam exiting the measurement device 001 is parallel light. The number of lenses included in the first lens group 412 may be selected according to optical path requirements and the design of the internal space of the product, and is not limited in this specification. For example, the first lens group 412 in FIG. 3 includes three lens units.

The second emitting module 420 includes a second emitter 421. The second emitter 421 is configured to emit a second emitted laser beam having a second wavelength to the target object during operation. For example, the second emitter 421 may be a laser diode capable of emitting laser light of the second wavelength. The second emitted laser beam is reflected by the target object into a second reflected laser beam. In some embodiments, the second emitting module 420 further includes a second lens group 422.

The second emitted laser beam passes through the second lens group 422 and then is incident on the target object. The second lens group 422 can collimate the second emitted laser beam such that the second emitted laser beam exiting the measurement device 001 is parallel light. This specification also does not limit the number of lenses included in the second lens group 422. For example, the second lens group 422 in FIG. 3 includes two lens units.

After the above-mentioned emitted laser beam reaches a distant target object, it is reflected by the target object into a reflected laser beam. For example, the first emitted laser beam is reflected into the first reflected laser beam, and the second emitted laser beam is reflected by the target object into the second reflected laser beam. If the measurement device 001 emits both the first emitted laser beam and the second emitted laser beam, the reflected laser beam includes the first reflected laser beam and the second reflected laser beam. The reflected laser light propagate back to the measurement device 001.

The receiving module 430 is configured to, during operation, receive a reflected laser beam and measure a target distance between the measurement device 001 and the target object based on the reflected laser beam. That is, the receiving module 430 may receive only the first reflected laser beam during operation. The receiving module 430 may alternatively receive only the second reflected laser beam during operation. The receiving module 430 may alternatively receive the first reflected laser beam and the second reflected laser beam at the same time during operation.

The first wavelength of the first emitted laser beam and the second wavelength of the second emitted laser beam are different, such that the first reflected laser beam and the second reflected laser beam have different wavelengths. The measurement device 001 may use the two reflected laser beams for distance measurement over different distance ranges.

For example, the first emitted laser beam may be continuous laser light. The first emitter 411 emits the first emitted laser beam. The receiving module 430 receives the first reflected laser beam reflected back by the target object. The receiving module 430 may measure the target distance based on the first reflected laser beam by a phase distance measurement method or a high-speed pulse phase distance measurement method. When the measurement device 001 uses the phase distance measurement method, the measurable distance is relatively short, but the distance measurement accuracy may reach the centimeter or even millimeter level. In some embodiments, the wavelength of the first emitted laser beam may be 650 nm±10 nm. In other embodiments, the wavelength of the first emitted laser beam may be 850 nm±10 nm.

The second emitted laser beam may be pulsed laser light. The second emitter 421 emits the second emitted laser beam. The receiving module 430 receives the second reflected laser beam reflected back by the target object. The receiving module 430 measures the target distance based on the second reflected laser beam by a time-of-flight distance measurement method. When the measurement device 001 uses the pulse distance measurement method, the measurable distance is relatively long, but the distance measurement accuracy is not as good as that of the phase distance measurement method. In some embodiments, the wavelength of the second emitted laser beam may be 905 nm±10 nm.

It can be seen that both the wavelengths of the first emitted laser beam and the second emitted laser beam fall within the infrared band. Infrared light is less susceptible to interference from sunlight and is therefore commonly used for distance measurement. Moreover, the emitters used in the measurement device 001 that can emit laser beams at 850 nm and 905 nm, respectively, are based on mature technology and are very low in cost. Since the laser wavelengths used by the two emitters are different and the distance measurement principles do not interfere with each other, integrated high-accuracy short distance measurement and long distance measurement can be achieved, thereby meeting various measurement requirements of users.

To receive the reflected laser beams, the receiving module 430 includes a photosensitive element 431. The photosensitive element 431 can detect laser light of the first wavelength and the second wavelength during operation. In other words, both the first wavelength of the first emitted laser beam and the second wavelength of the second emitted laser beam may fall within the sensing band of the same photosensitive element 431. Thus, by providing the single photosensitive element 431, the receiving module 430 can simultaneously receive the first reflected laser beam and the second reflected laser beam during operation, thereby reducing the space occupied by the laser measurement assembly within the measurement device 001.

The single photosensitive element 431 has a sensing peak. That is, the photosensitive element 431 has a high responsivity for some wavelengths and a lower responsivity for others. Therefore, to ensure that the first reflected laser beam and the second reflected laser beam can be detected at the same time by using only one single photosensitive element 431, and under the premise that the wavelengths of the first emitted laser beam and the second emitted laser beam can achieve distance measurement over different distance ranges, the first wavelength and the second wavelength may be selected as approximate wavelength values in the vicinity of the sensing peak, such that the photosensitive element 431 has a high responsivity to both the first reflected laser beam and the second reflected laser beam. For example, the first wavelength of the first emitted laser beam may be 850 nm±10 nm. The second wavelength of the second emitted laser beam may be 905 nm±10 nm. A maximum difference between the first wavelength and the second wavelength is only 55 nm. Correspondingly, the photosensitive element 431 may be selected as an element having a peak sensing wavelength range of 840 nm to 915 nm, ensuring a high responsivity in the range of 840 nm to 915 nm. For example, the responsivity of the photosensitive element in the range of 840 nm to 915 nm exceeds 50%. In some embodiments, the receiving module 430 may further include a filter. The filter may be a broadband filter, and specifically a broadband filter of which the passband includes 840 nm to 915 nm. The filter can block light of other wavelengths and only allow laser light with wavelengths of 840 nm to 915 nm to transmit therethrough, thereby enhancing the receiving efficiency of the photosensitive element 431 for laser light in the distance measurement band.

Since the reflected laser beams received by the receiving module 430 are different, the measurement device 001 can perform distance measurement in different modes. The measurement range and measurement accuracy of the measurement device 001 are different in different modes.

In a first mode, the first emitting module 410 operates to emit the first emitted laser beam. The photosensitive element 431 can detect the first reflected laser beam. The receiving module 430 measures the target distance based on the first reflected laser beam. For example, as described above, the receiving module 430 measures the target distance based on the continuous laser light of 850 nm±10 nm. In this case, the measurement device 001 is in a short distance measurement mode, with a corresponding measurement range of the target distance of from 0 m to 50 m and a measurement accuracy of ±2.5 cm.

In a second mode, the second emitting module 420 operates to emit the second emitted laser beam. The photosensitive element 431 can detect the second reflected laser beam. The receiving module measures the target distance based on the second reflected laser beam. For example, as described above, the receiving module 430 measures the target distance based on the pulsed laser light of 905 nm±10 nm. In this case, the measurement device 001 is in a long distance measurement mode, with a corresponding measurement range of the target distance of greater than 50 m and a measurement accuracy of ±45 cm.

According to actual distance measurement requirements, the measurement device 001 may also have both the first mode and the second mode. Alternatively, when the measurement device 001 has both the first mode and the second mode, it can be considered that the measurement device 001 has a third mode. In the third mode, the measurement device 001 simultaneously executes the first mode and the second mode.

That is, in the third mode, the first emitting module 410 and the second emitting module 420 operate simultaneously. The photosensitive element 431 detects the first reflected laser beam and the second reflected laser beam at the same time. The receiving module 430 can measure the target distance based on the first reflected laser beam and the second reflected laser beam. An operating mode of the measurement device 001 may be manually switched by the user. The measurement device 001 may also automatically switch the operating mode. The selection of the operating mode and the distance measurement method will be described below.

Returning to FIG. 2, the receiving module 430 further includes an optical receiving assembly 432. The optical receiving assembly 432 includes a measuring incident end 432A and a measuring exit end 432B. The photosensitive element 431 is located at the measuring exit end 432B. The first reflected laser beam and the second reflected laser beam enter the optical receiving assembly 432 from the measuring incident end 432A and then propagate along a same measuring optical path P1 to the measuring exit end 432B so as to enter the photosensitive element 431.

The measurement device 001, especially the measurement device 001 used for golf, generally also has a viewing function. That is, the measurement device 001 is integrated with viewing and measurement functions. For example, it is integrated with telescopic function and measurement function. Therefore, in some embodiments, the measurement device 001 further includes a telescope assembly 500. As shown in FIG. 1, the telescope assembly 500 may be mounted inside the housing 200. The telescope assembly 500 may be configured to observe distant objects. Especially when the measurement device 001 is used in a golf distance measurement scenario, since a golf course is large, the telescope assembly 500 may be configured to magnify a distant target object to enable viewing, magnification, and resolution of the target object. As shown in FIG. 2, the telescope assembly 500 may include an objective lens group (objective lens part) 510 and an eyepiece group (eyepiece part) 520. The objective lens group 510 may be mounted at the first end 210. The objective lens group 510 is composed of a series of lenses and is located at an end near the object to magnify the target object. The eyepiece group 520 is composed of a series of lenses and is located at an end near the human eye.

The eyepiece group 520 is mounted at the second end 220 and is in moving connection with the second end 220 along an optical axis of the eyepiece group 520.

For ease of description, the optical receiving assembly is described as including the objective lens group 510 and the eyepiece group 520 as an example.

Therefore, the optical receiving assembly 432 further includes a viewing incident end 432C and a viewing exit end 432D. Ambient light enters the optical receiving assembly 432 via the viewing incident end 432C, propagates along a viewing optical path P2, and exits from the viewing exit end 432D. The viewing optical path and the measuring optical path are two different optical paths. The end point of the viewing optical path P2 is the user's eye, and the end point of the measuring optical path P1 is the photosensitive element 431.

The structure in FIG. 2 is designed such that both ambient light and the reflected laser beams are incident from the same incident end (objective lens group 510) to reduce the number of components. Therefore, the viewing incident end 432C and the measuring incident end 432A are located at the same position. However, according to different designs, the positions of the viewing incident end 432C and the measuring incident end 432A may also be different. This is not limited in this specification. For ease of description, this specification takes the structure shown in FIG. 2 as an example for illustration. However, those skilled in the art will understand that the invention described in this specification can also be applied to structures where the positions of the viewing incident end 432C and the measuring incident end 432A are different without departing from the spirit of the present application.

To reduce the volume of the measurement device 001 and minimize the internal space occupied by components, the optical paths inside the measurement device 001 often share part of the optical receiving assembly, and therefore, the two different optical paths partially coincide.

For example, as shown in FIG. 2, the measuring optical path of the measurement assembly 400 and the viewing optical path P2 of the telescope assembly 500 share part of the optical receiving assembly 432, and the two different optical paths partially coincide.

The optical receiving assembly 432 may further include the objective lens group 510, the eyepiece group 520, and a beam splitting module 4322.

The objective lens group 510 serves as both the measuring incident end 432A and the viewing incident end 432C. The beam splitting module 4322 is located between the objective lens group 510 and the eyepiece group 520. The beam splitting module 4322 includes a first incident end 4322a, a first exit end 4322b, and a second exit end 4322d. The eyepiece group 520 faces the first exit end 4322b. In some embodiments, the beam splitting module 4322 further includes a second incident end 4322c (not shown in FIG. 2).

The objective lens group 510 is located at the measuring incident end 432A. The photosensitive element 431 is located at the measuring exit end 432B. The reflected laser beam reflected back by the target object enters the measurement device 001 through the objective lens group 510, enters the beam splitting module 4322 from the first incident end 4322a, propagates along the measuring optical path P1, exits the beam splitting module 4322 from the second exit end 4322d, and finally enters the photosensitive element 431.

Both the first reflected laser beam and the second reflected laser beam enter the photosensitive element 431 along the same measuring optical path P1.

The objective lens group 510 is also located at the viewing incident end 432C, and the eyepiece group 520 is located at the viewing exit end. Ambient light enters the measurement device 001 through the objective lens group 510, also enters the beam splitting module 4322 from the first incident end 4322a, propagates along the viewing optical path P2, exits the beam splitting module 4322 from the first exit end 4322b, and then enters the eyepiece group 520. The target object may be magnified by a preset magnification through the objective lens group 510, the beam splitting module 4322, and the eyepiece group 520, and then “sent” to the user's eye, allowing the user to see the distant target object clearly. The objective lens group 510 and the eyepiece group 520 may be arranged in a straight line to form a straight-tube telescope, as shown in FIG. 2. In some embodiments, the objective lens group 510 and the eyepiece group 520 may not be in a straight line. The positions of the objective lens group 510 and the eyepiece group 520 may be selected according to the internal layout of the measurement device 001, and are not limited in this specification. This specification also does not limit the numbers, types (convex lens and concave lens), or parameters (radius of curvature, center deviation, etc.) of the lenses in the objective lens group 510 and the eyepiece group 520.

FIG. 4 illustrates a diagram of internal optical paths of a beam splitting module 4322 of a measurement device 001 according to some embodiments of this specification. The measuring optical path P1 is shown by a solid line, and the viewing optical path P2 is shown by a dashed line. The beam splitting module 4322 may include a first prism 4322A, a second prism 4322B, and a third prism 4322C.

The first prism 4322A may include the above-mentioned first incident end 4322a and a beam splitting surface 4322e. The first incident end 4322a is configured to receive ambient light. When the measurement device 001 is used for distance measurement, the first incident end 4322a may also be configured to receive the reflected laser beam. The first prism 4322A may be a semi-pentaprism.

The second prism 4322B is located between the first prism 4322A and the eyepiece group 520. The second prism 4322B includes the above-mentioned first exit end 4322b. The second prism 4322B is configured to receive the ambient light exiting from the first prism 4322A and guide the ambient light to propagate along the viewing optical path P2, exit the beam splitting module 4322 from the first exit end 4322b, and then enter the eyepiece group 520. The second prism 4322B may be a roof prism.

The third prism 4322C is located between the first prism 4322A and the photosensitive element 431. The third prism 4322C includes the above-mentioned second exit end 4322d. The third prism 4322C is configured to receive the reflected laser beam exiting from the first prism 4322A and guide the reflected laser beam to propagate along the measuring optical path P1, exit the beam splitting module 4322 from the second exit end 4322d, and finally enter the photosensitive element 431. The third prism 4322C may be a compensating prism.

The first prism 4322A may be cemented to the third prism 4322C to reduce light energy loss. Moreover, the cemented surface S between the first prism 4322A and the third prism 4322C may be coated with a beam splitting film. The beam splitting film can reflect visible light and transmit infrared light, thereby causing the originally coinciding viewing optical path and measuring optical path to diverge, so that the ambient light and the reflected laser beam propagate in different directions.

For example, as shown in FIG. 4, the ambient light enters the first prism 4322A from the objective lens group 510, then is reflected on a surface of the first prism 4322A, then is incident on and reflected by the cemented surface S, and then enters the second prism 4322B. After being reflected three times within the second prism 4322B, the ambient light exits along the optical axis of the eyepiece group 520 and finally enters the user's eye. The reflected laser beam also enters the first prism 4322A from the objective lens group 510, then is reflected on a surface of the first prism 4322A and incident on the cemented surface S, transmits through the cemented surface S, is incident on the third prism 4322C, and then exits from the third prism 4322C to the photosensitive element 431. In some embodiments, the receiving module 430 further includes a first reflective mirror group 433. The reflected laser beam exiting from the third prism 4322C is incident on the first reflective mirror group 433, then changes its propagation direction, and finally enters the photosensitive element 431. By providing the first reflective mirror group 433, the propagation direction of the reflected laser beam can be changed, so that the position of the photosensitive element 431 can be adjusted according to layout requirements, offering greater flexibility. The number of reflective mirrors included in the first reflective mirror group 433 may be selected according to optical path requirements and the design of the internal space of the product, and is not limited in this specification. For example, FIG. 4 shows one reflective mirror. The propagation direction of the reflected laser beam is changed only once by the first reflective mirror group 433.

The surfaces of the prisms in the beam splitting module 4322 may alternatively be coated with other films. For example, the first incident end 4322a may be coated with an anti-reflection film for visible light (ambient light), 905 nm wavelength, and 850 nm wavelength. For another example, the first exit end 4322b may be coated with an anti-reflection film for visible light. With the anti-reflection films coated, reflected light from optical surfaces such as lenses, prisms, and mirrors can be reduced or eliminated, thereby increasing the light transmission of these elements and reducing or eliminating stray light in the system. The anti-reflection film and the beam splitting film may be formed on the prism surfaces by thin-film preparation processes, or films prepared through thin-film processes may be attached to the prism surfaces. This is not limited in this specification.

As described above, to reduce the volume of the measurement device 001 and minimize the internal space occupied by components, the optical paths inside the measurement device 001 often share part of the optical receiving assembly, and therefore, the two different optical paths partially coincide. FIG. 4 shows that the receiving optical paths of the viewing optical path and the measuring optical path share part of the optical receiving assembly. In addition, the emitting optical paths of the viewing optical path and the measuring optical path may also share part of the optical receiving assembly. FIG. 5 illustrates a diagram of another measuring optical path and viewing optical path according to some embodiments of this specification. The measuring optical path P1 is shown by a solid line, and the viewing optical path P2 is shown by a dashed line.

As shown in FIG. 5, the first emitted laser beam emitted by the first emitter 411 passes through the first lens group 412, is then incident on the beam splitting module 4322, exits the beam splitting module 4322, and is incident on the objective lens group 510 and then incident on the target object. The second emitted laser beam emitted by the second emitter 421 passes through the second lens group 422 and then exits to the target object. In this case, the reflected laser beam reflected back by the target object no longer passes through the beam splitting module 4322, but may be directly incident on the photosensitive element 431, or may be incident on the photosensitive element 431 after passing through the first reflective mirror group 433 (not shown in FIG. 5) or a lens group.

It should be understood that since the structure in FIG. 5 is derived from FIG. 2 to FIG. 4, all the technical solutions in FIG. 2 to FIG. 4 described above are applicable to the structure in FIG. 5.

In some embodiments, the measuring optical path and the viewing optical path may pass through different optical assemblies, and the two optical paths may be completely non-coincident. The specific structure of the measuring optical path and the viewing optical path is not limited in this specification.

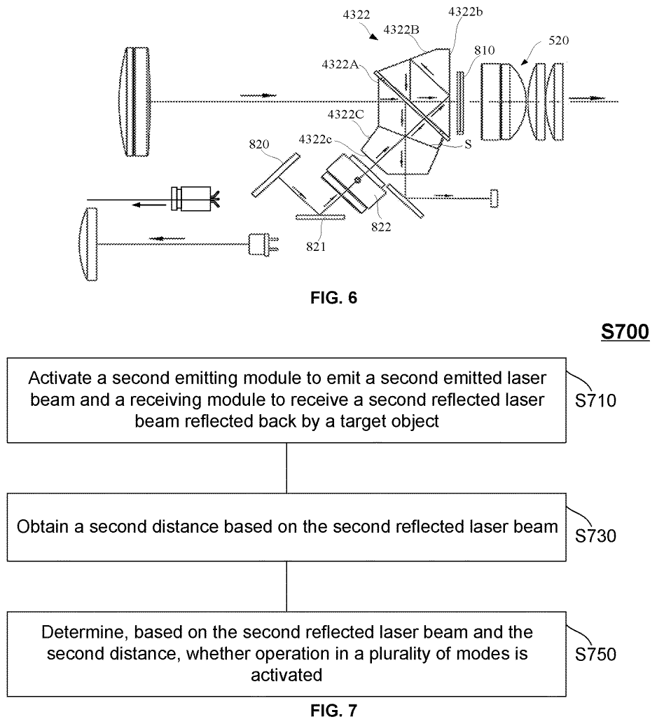

After obtaining the target distance, the measurement device 001 needs to display the distance value. On the measurement device 001 used in golf, information such as slope and wind speed also needs to be displayed. To this end, the measurement device 001 may include a display module. For example, FIG. 6 illustrates a structural schematic diagram of a measurement device 001 with a dual-display module according to some embodiments of this specification. The basic structure of this configuration is based on the structure of the measurement device 001 shown in FIG. 2 to FIG. 4, with a display module added on this basis. Therefore, all the technical solutions in FIG. 2 to FIG. 4 described above are applicable to the structure in FIG. 6.

The measurement device 001 may include a first display module 810. The first display module 810 may be located between the eyepiece group 520 and the beam splitting module 4322. The first display module 810 may be a transparent organic light emitting diode (OLED) or a transparent liquid crystal display (LCD). The first display module 810 is described using an LCD as an example. The first display module 810 may output a first display signal toward the eyepiece group 520 during operation. The first display signal may include information such as the distance value and slope. Therefore, the user can see the target object, the background, and the information on the display simultaneously from the eyepiece group 520.

In daytime or when ambient light is sufficient, natural light enters the measurement device 001 from the objective lens group 510 and is incident on the back of an LCD display element, serving as backlight for the first display module 810. However, at night or when the ambient light is dim, since the LCD displays in black and white without backlight, the data displayed on the LCD at night cannot be seen clearly. If a backlight source is added behind the LCD display element, the backlight source would block the light and affect the user's observation of the target object. Therefore, in some embodiments, the measurement device 001 further includes a second display module 820.

The second display module 820 may be an OLED display element. Specifically, the second display module 820 may be a red-light OLED display element, which can display very clearly at night. The second display module 820 is configured to output a second display signal during operation.

As described previously, the beam splitting module 4322 may further include the second incident end 4322c. Specifically, when the second display module 820 is located below the beam splitting module 4322, the third prism 4322C may include the second incident end 4322c. The second display signal enters the beam splitting module 4322 from the second incident end 4322c, exits the beam splitting module 4322 from the first exit end 4322b, and then is output toward the eyepiece group 520.

The propagation path of the second display signal is illustrated by taking the beam splitting module 4322 in FIG. 6 as an example. The light (second display signal) emitted by the second display module 820 passes through the third prism 4322C, is transmitted through the cemented surface S into the first prism 4322A, then enters the second prism 4322B, and after being reflected three times within the second prism 4322B, exits the beam splitting module 4322 and is output toward the eyepiece. As described previously, the cemented surface S may be coated with the beam splitting film. The beam splitting film can reflect visible light and transmit infrared light. When the second display module 820 is provided, the beam splitting film also needs to allow the light from the OLED display to transmit therethrough.

In some embodiments, the measurement device 001 further includes a second reflective mirror group 821 and a third lens group 822 for use in conjunction with the second display module 820. As shown in FIG. 6, the second display signal is incident on the second reflective mirror group 821 and then is reflected to the third lens group 822, and is incident on the beam splitting module 4322 only after passing through the third lens group 822.

The display positions of the first display signal and the second display signal in front of the eyepiece group 520 may be the same. Two display modules are provided such that the first display module 810 displays information during the daytime and the second display module 820 displays information at night, so that the measurement device 001 can clearly display data both during the daytime and at night, thereby facilitating the user in reading the data.

FIG. 7 illustrates a flowchart of a laser distance measurement method S700 according to some embodiments of this specification. The distance measurement method S700 may be applied to the measurement device 001 described above. The method S700 may be performed by a controller in the measurement device 001. The method S700 may include the following steps.

In step S710, a second emitting module is activated to emit a second emitted laser beam and a receiving module is activated to receive a second reflected laser beam reflected back by a target object.

The second emitted laser beam may be pulsed laser light. The second emitted laser beam may be used for long distance measurement.

In step S730, a second distance is obtained based on the second reflected laser beam.

The receiving module 430 may obtain the second distance based on the second reflected laser beam by a time-of-flight distance measurement method. A wide range can be covered by using the time-of-flight distance measurement method, but the data accuracy of the obtained second distance is relatively low. As described previously, the measurement accuracy is ±45 cm.

In step S750, whether operation in a plurality of modes is activated is determined based on the second reflected laser beam and the second distance.

In the plurality of modes, the laser measurement device 001 (controller) activates a first emitting module 410 to emit a first emitted laser beam and the receiving module 430 to receive a first reflected laser beam reflected back by the target object. The first emitted laser beam may be continuous laser light. The first emitted laser beam may be used for short distance measurement. When the second distance is less than a distance threshold, the distance between the target object and the user is relatively short, short distance measurement can be performed, thereby obtaining data with higher accuracy. For example, the distance threshold may be 50 m.

Specifically, when the controller determines that the reflective surface quality for the second reflected laser beam meets a preset condition and the second distance is less than the distance threshold, the operation in the plurality of modes is activated.

When the second distance is less than 50 m, the target object is within a short distance range, i.e., within the measurable range for the first reflected laser beam. Thus, to obtain data with higher accuracy, the controller activates the first emitting module 410. The second reflected laser beam received by the receiving module 430 may also contain information about the target object or the surface region (reflective surface) of the target object. Because different target objects have their own material surface reflection characteristics, variables such as reflectivity, reflection azimuth, roughness, and color (collectively referred to as reflective surface quality) will, to some extent, affect the optical power that the laser receiving module 430 can receive, thereby influencing the distance measurement accuracy within the measurement range. The preset condition may be that the reflective surface quality of the target object is such that the ratio of the power of the laser light received by the receiving module 430 to the output power of the laser light exceeds a preset value. For example, the ratio of the power of the second reflected laser beam to the power of the second emitted laser beam is greater than the preset value.

If the reflective surface quality does not meet the preset condition, i.e., the surface reflection characteristics of the target object result in low optical power of the laser light received by the receiving module 430, the data obtained using the first emitted laser beam would have low reliability and low accuracy, and the controller will not activate the first emitting module 410.

When the controller determines that the reflective surface quality for the second reflected laser beam does not meet the preset condition or the second distance is greater than the distance threshold, the second distance may be directly output as the target distance.

After the measurement device 001 (controller) activates the operation in the plurality of modes, the controller may obtain a first distance based on the first reflected laser beam. Then, the controller may determine and output the target distance based on the first distance and the second distance. When the first distance is invalid data, the target distance is the second distance. When the first distance is valid data, the target distance is the first distance.

Specifically, if the first distance is valid, the controller will output the first distance as the target distance because the first distance has higher accuracy. Whether the first distance is valid may be determined by the controller. For example, the first distance may be considered valid if the absolute value of the difference between the first distance and the second distance is greater than a first preset value and less than a second preset value. The absolute value of the difference between the first distance and the second distance is required to be greater than the first preset value because the first distance and the second distance are different in measurement accuracy and thus generally have different values. The difference between the first distance and the second distance needs to correspond to the difference in measurement accuracy. The absolute value of the difference between the first distance and the second distance is required to be less than the second preset value so as to ensure the reliability of the first distance value. If the difference between them is large, an error may occur during the distance measurement of the measurement device 001 using the first emitted laser beam, and therefore the first distance should be discarded. In this case, the target distance is the second distance.

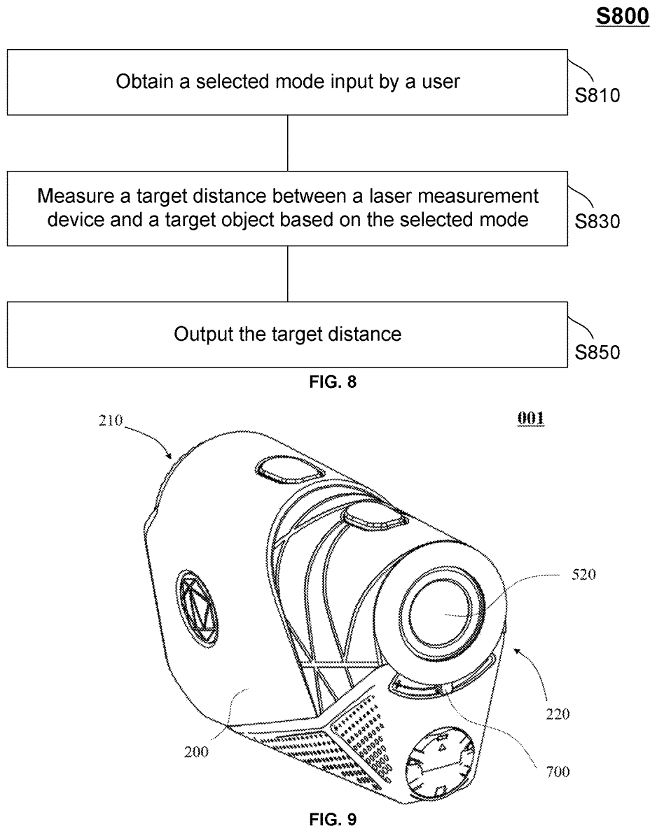

FIG. 8 illustrates a flowchart of another laser distance measurement method S800 according to some embodiments of this specification. The distance measurement method S800 may be applied to the measurement device 001 described above. The method S800 may be performed by a controller in the measurement device 001. The method S800 may include the following steps.

In step S810, a selected mode input by a user is obtained.

The selected mode input by the user is a first mode or a second mode. In the first mode, a first emitting module emits a first emitted laser beam, and in the second mode, a second emitting module emits a second emitted laser beam.

The first mode may be a short distance measurement mode. In the first mode, the first emitting module emits the first emitted laser beam. The first emitted laser beam may be continuous laser light. A receiving module 430 obtains a first distance based on the first reflected laser beam by a phase distance measurement method.

The second mode may be a long distance measurement mode. In the second mode, the second emitting module emits the second emitted laser beam. The second emitted laser beam may be pulsed laser light. The receiving module 430 obtains a second distance based on the second reflected laser beam by a time-of-flight distance measurement method.

The measurement device 001 may be provided with two keys for the user to select modes. The controller may obtain the mode selected by the user via the key selected by the user. The measurement device 001 may also be provided with an input interface for the user to input the selected mode. This specification does not limit the method by which the measurement device 001 (controller) obtains the selected mode input by the user.

The user may first visually estimate the approximate distance from the user (the measurement device 001) to the target object. For example, the user visually estimates that the distance between the user and the target object exceeds 100 m. In this case, it is highly likely that the short distance measurement mode cannot obtain valid data, and the user does not require such high measurement accuracy. Then, the user can directly manually select the second mode, i.e., the long distance measurement mode.

In step S830, a target distance between the laser measurement device and a target object is measured based on the selected mode.

In step S850, a target distance is output.

To sum up, the measurement device 001 can meet users' measurement needs for different distances and obtain highly accurate distance measurement values.

In some embodiments, the measurement device 001 further includes a diopter adjustment assembly. As described previously, the eyepiece group 520 may be mounted at the second end 220 and be in moving connection with the second end 220 along the optical axis of the eyepiece group 520. That is, the eyepiece group 520 may move relative to the housing 200 along the optical axis of the eyepiece group 520 to adjust the position of the focal point of the eyepiece group 520, thereby adjusting the diopter of the eyepiece group 520 to accommodate the user's vision, so that eyes with different visual acuities can obtain a clear visual image.

The diopter adjustment range of the eyepiece group 520 varies depending on the specific application scenario. For example, when monitoring the position change of a workpiece in manufacturing, the diopter adjustment range of the eyepiece group 520 may be between −20 D and +20 D. For example, when measuring the distance between an athlete and a target on a golf course, the diopter adjustment range of the eyepiece group 520 may be between −10 D and +10 D. For another example, when measuring room dimensions in interior design and decoration, the diopter adjustment range of the eyepiece group 520 may be between −5 D and +5 D, and so on. In practical use, the diopter adjustment range of the eyepiece group 520 may be set according to the specific usage scenarios and is not limited herein.

FIG. 9 illustrates a structural schematic diagram of a measurement device 001 according to some embodiments of this specification. As shown in FIG. 9, a diopter adjustment assembly 700 may be mounted at the second end 220. The diopter adjustment assembly 700 may movably connected to the eyepiece group 520 to adjust the position of the eyepiece group 520 relative to the housing 200 along the optical axis. The specific structure of the movable connection will be described in detail later.

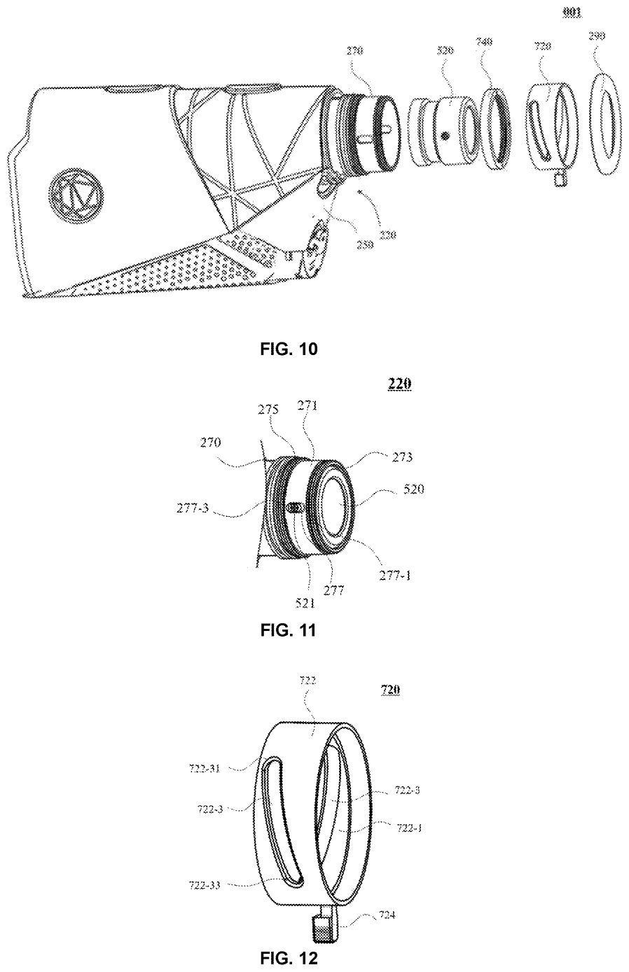

FIG. 10 illustrates an exploded structural schematic diagram of a measurement device 001 according to some embodiments of this specification. As shown in FIG. 10, the housing 200 may include an inner housing 270 and an outer housing 250. Both the inner housing 270 and the outer housing 250 are wall-type components. The inner housing 270 may serve as a mounting base for a measurement assembly 400 and a telescope assembly 500. The measurement assembly 400 and the telescope assembly 500 may be mounted within an accommodating cavity formed by the inner housing 270. The outer housing 250 may be in fixed connection with the inner housing 270 and cover the inner housing 270. The inner housing 270 is in fixed connection with the outer housing 250. There are a plurality of ways to achieve the fixed connection, such as integrated molding, threaded connection, welding, riveting, adhesive bonding, snap-fit connection, and mortise-and-tenon connection, which will not be limited in this specification. As described previously, the housing 200 may include a first end 210 and a second end 220. The first end 210 may be an end of the outer housing 250 or an end of the inner housing 270. The second end 220 may be an end of the outer housing 250 or an end of the inner housing 270.

The eyepiece group 520 may be in moving connection with the second end 220 of the inner housing 270 along the optical axis of the eyepiece group 520 thereby achieving the movable connection of the eyepiece group 520 relative to the housing 200 along the optical axis of the eyepiece group 520.

The housing 200 further includes an end cap 290. The end cap 290 is disposed at the second end 220 and covers the diopter adjustment assembly 700. Specifically, the end cap 290 may cover the side of the diopter adjustment assembly 700 facing the outside of the housing 200 (i.e., facing the human eye). The end cap 290 may also cover the side of the eyepiece group 520 facing the outside of the housing 200 (i.e., facing the human eye).

The end cap 290 may be mounted on the outer housing 250 or on the inner housing 270. As shown in FIG. 10, the description will be made by taking as an example that the end cap 290 is in fixed connection with the outer housing 250. The fixed connection between the end cap 290 and the outer housing 250 includes, but is not limited to, integrated molding, threaded connection, adhesive bonding, riveting, welding, snap-fit connection, mortise-and-tenon connection, etc. The fixed connection between the end cap 290 and the outer housing 250 shown in FIG. 10 is a snap-fit connection. The end cap 290 may be provided with an observation hole 291. The user can view the eyepiece group 520 through the observation hole 291. The material of the end cap 290 may be any material, such as metals, plastics, and silicone. To improve comfort, the material of the end cap 290 may be a soft material, such as silicone and rubber.

As shown in FIG. 10, the diopter adjustment assembly 700 may include an adjusting knob 720. The adjusting knob 720 may be in rotary connection with the second end 220. For example, the adjusting knob 720 may be in rotary connection with the second end 220 of the inner housing 270, or in rotary connection with the second end 220 of the outer housing 250. For ease of illustration, the following description will be made by taking as an example that the adjusting knob 720 is in rotary connection with the second end 220 of the inner housing 270. The adjusting knob 720 may also be in helical connection with the eyepiece group 520 along the optical axis of the eyepiece group 520. Since the eyepiece group 520 is in helical connection with the adjusting knob 720 along the optical axis of the eyepiece group 520, the adjusting knob 720 may drive the eyepiece group 520 to move helically relative to the adjusting knob 720. In this case, the helical movement of the eyepiece group 520 relative to the adjusting knob 720 may be divided into rotation relative to the circumferential direction of the adjusting knob 720 and movement relative to the axial direction of the adjusting knob 720 (i.e., along the optical axis). Meanwhile, since the eyepiece group 520 is in moving connection with the housing 200 along the optical axis, the eyepiece group 520 cannot rotate relative to the housing 200. Therefore, when the adjusting knob 720 is rotated, the adjusting knob 720 may drive the eyepiece group 520 to move along the optical axis. Therefore, the user does not need to directly adjust the eyepiece group 520 to achieve diopter adjustment, and the eyepiece group 520 does not need to be exposed outside the housing 200. Observation can be achieved through the eyepiece group 520 during use. Since the adjusting knob 720 is provided separately and independently from the eyepiece group 520, accidental operation of the adjusting knob 720 is avoided, providing better user experience.

The diopter adjustment assembly 700 may further include an axial limiting piece 740. The axial limiting piece 740 may be configured to axially position the adjusting knob 720, preventing the adjusting knob 720 from moving in the axial direction relative to the second end 220 of the inner housing 270.

FIG. 11 illustrates a structural schematic diagram of a second end 220 of an inner housing 270 and an eyepiece group 520 according to some embodiments of this specification. As shown in FIG. 11, the second end 220 of the inner housing 270 may include a connecting shaft 271. The connecting shaft 271 may be configured for mounting with the adjusting knob 720. One end of the connecting shaft 271 may be provided with a positioning boss 275. The positioning boss 275 can prevent the adjusting knob 720 from moving along the optical axis of the eyepiece group 520 during rotation. The positioning boss 275 may be disposed at an end of the connecting shaft 271 close to the inner side of the housing 200. The positioning boss 275 protrudes relative to the connecting shaft 271 in the radial direction of the connecting shaft 271. When the adjusting knob 720 is mounted on the connecting shaft 271, the positioning boss 275 may abut against one side of the adjusting knob 720 (e.g., the side of the adjusting knob 720 facing the inside of the housing 200), and the axial limiting piece 740 may abut against another side of the adjusting knob 720 (e.g., the side of the adjusting knob 720 facing the outside of the housing 200), so that the adjusting knob 720 is axially fixed relative to the connecting shaft 271. The axial limiting piece 740 and the connecting shaft 271 may be fixedly connected via screw thread, or may be clamped via a clamping slot, etc.

The second end 220 of the inner housing 270 may be provided with an eyepiece hole 273. Specifically, the eyepiece hole 273 may be provided on the connecting shaft 271. The eyepiece hole 273 may be configured to mount the eyepiece group 520. The eyepiece hole 273 is adapted to fit the eyepiece group 520. Being adapted to fit may refer to the eyepiece hole 273 and the eyepiece group 520 matching in size and shape. For example, both the eyepiece hole 273 and the eyepiece group 520 are cylindrical.

In some embodiments, the connecting shaft 271 may be provided with a moving slot 277. The moving slot 277 may be provided on the eyepiece hole 273. The moving slot 277 penetrates through the sidewall of the connecting shaft 271 along the radial direction of the connecting shaft 271. Meanwhile, the moving slot 277 extends along the optical axis of the eyepiece group 520. The moving slot 277 may be configured for moving connection with the eyepiece group 520 along the optical axis of the eyepiece group 520. The number of moving slots 277 may be one or more, for example, 2, 3, 4, or 5. A plurality of moving slots 277 may be uniformly or non-uniformly distributed along the circumferential direction of the connecting shaft 271. Each moving slot 277 includes a first limiting portion 277-1 and a second limiting portion 277-3. The first limiting portion 277-1 and the second limiting portion 277-3 are the ends of the moving slot 277 in the extension direction. The eyepiece group 520 may move between the first limiting portion 277-1 and the second limiting portion 277-3 relative to the inner housing 270.

A guide pillar 521 is disposed on the eyepiece group 520. The guide pillar 521 protrudes in the radial direction of the eyepiece group 520. When the eyepiece group 520 is mounted on the inner housing 270, the guide pillar 521 may be configured for connection with the moving slot 277. The guide pillar 521 may pass through the moving slot 277 and be slidably connected to the moving slot 277, thereby achieving the moving connection of the eyepiece group 520 relative to the inner housing 270 along the optical axis of the eyepiece group 520. When the guide pillar 521 is moved along the optical axis of the eyepiece group 520, the guide pillar 521 moves between the first limiting portion 277-1 and the second limiting portion 277-3. The height of the guide pillar 521 may be greater than the thickness of the sidewall of the connecting shaft 271. When the eyepiece group 520 is mounted on the inner housing 270, the guide pillar 521 passes through the moving slot 277 and protrudes in the radial direction relative to the connecting shaft 271. It should be noted that the guide pillar 521 may be detachably connected to the eyepiece group 520. The number of guide pillars 521 may be one or more, for example, 2, 3, 4, or 5. It should be noted that the number of guide pillars 521 is the same as that of moving slots 277.

FIG. 12 illustrates a structural schematic diagram of an adjusting knob 720 according to some embodiments of this specification. In some embodiments, the adjusting knob 720 may include a rotary connecting portion 722. In some embodiments, the adjusting knob 720 may further include a toggle 724.

As described previously, the rotary connection of the adjusting knob 720 with the second end 220 of the inner housing 270 and the helical connection with the eyepiece group 520 can be achieved by a rotary connecting portion 722. The rotary connecting portion 722 may be in rotary connection with the connecting shaft 271 of the inner housing 270. The rotary connecting portion 722 may include a connecting hole 722-1. The connecting shaft 271 is in rotary connection with the connecting hole 722-1. The positioning boss 275 and the axial limiting piece 740 respectively abut against two sides of the rotary connecting portion 722, such that the rotary connecting portion 722 is axially fixed relative to the connecting shaft 271.

The rotary connecting portion 722 is provided with a guide slot 722-3. The guide slot 722-3 helically extends in the circumferential direction of the rotary connecting portion 722. The helical extension may refer to shifting in the axial direction while extending in the circumferential direction along the surface of the rotary connecting portion 722. The helical extension may be a linear helical extension or a non-linear helical extension. The guide slot 722-3 may penetrate through the sidewall of the rotary connecting portion 722 along the radial direction of the rotary connecting portion 722. The guide slot 722-3 may be configured for helical connection with the eyepiece group 520 along the optical axis of the eyepiece group 520. Specifically, the eyepiece group 520 may be slidably connected to the rotary connecting portion 722 along the guide slot 722-3. The guide pillar 521 of the eyepiece group 520 may pass through the guide slot 722-3, thereby achieving a sliding connection between the eyepiece group 520 and the adjusting knob 720 along the guide slot 722-3. The guide slot 722-3 includes a third limiting portion 722-31 and a fourth limiting portion 722-33. The third limiting portion 722-31 and the fourth limiting portion 722-33 are the ends of the guide slot 722-3 in the extension direction. When the eyepiece group 520 is moved relative to the housing 200 along the optical axis of the eyepiece group 520, the guide pillar 521 may move between the third limiting portion 722-31 and the fourth limiting portion 722-33. When the guide pillar 521 abuts against the first limiting portion 277-1 or the second limiting portion 277-3, the guide pillar 521 is located between the third limiting portion 722-31 and the fourth limiting portion 722-33. The number of guide slots 722-3 may be one or more, for example, 2, 3, 4, or 5. It should be noted that the number of guide slots 722-3 is the same as that of guide pillars 521.

Since the guide slot 722-3 helically extends in the circumferential direction of the rotary connecting portion 722, the rotary connecting portion 722 may drive the eyepiece group 520 to move helically relative to the rotary connecting portion 722. In this case, the helical movement of the eyepiece group 520 relative to the rotary connecting portion 722 may be divided into rotation relative to the circumferential direction of the rotary connecting portion 722 and movement relative to the axial direction of the rotary connecting portion 722 (i.e., along the optical axis). Meanwhile, since the eyepiece group 520 is in moving connection with the moving slot 277 along the optical axis, the eyepiece group 520 cannot rotate relative to the housing 200. Therefore, when the rotary connecting portion 722 is rotated, the rotary connecting portion 722 may drive the eyepiece group 520 to move along the optical axis. Therefore, the user does not need to directly adjust the eyepiece group 520 to achieve diopter adjustment, and the eyepiece group 520 does not need to be exposed outside the housing 200. Observation can be achieved through the eyepiece group 520 during use. Since the adjusting knob 720 is provided separately and independently from the eyepiece group 520, accidental operation of the adjusting knob 720 is avoided, providing better user experience.

To further prevent the user from accidentally touching the adjusting knob 720, the rotary connecting portion 722 may be covered by the housing 200. The rotary connecting portion 722 may be located between the inner housing 270 and the outer housing 250. The end cap 290 may cover the side of the rotary connecting portion 722 facing the outside of the housing 200. In this case, the adjusting knob 720 may further include a toggle 724. The toggle 724 may be disposed on the rotary connecting portion 722. The toggle 724 may pass through the housing 200 and be exposed outside the housing 200. The user can rotate the rotary connecting portion 722 by turning the toggle 724. The toggle 724 may be in fixed connection with the rotary connecting portion 722. The fixed connection includes, but is not limited to, integrated molding, threaded connection, adhesive bonding, riveting, welding, snap-fit connection, mortise-and-tenon connection, etc. In some embodiments, the toggle 724 may be disposed in the radial direction of the rotary connecting portion 722. In the operating state of the measurement device 001, the toggle 724 may be located below the rotary connecting portion 722. It should be noted that the operating state of the measurement device 001 may refer to the attitude of the measurement device 001 in use. In some embodiments, the toggle 724 may alternatively be disposed in the axial direction of the rotary connecting portion 722.

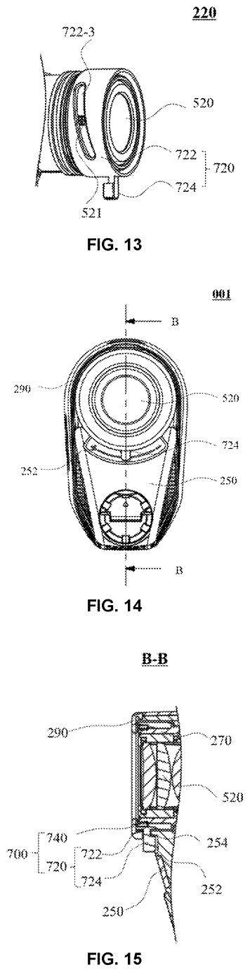

FIG. 13 illustrates a structural schematic diagram of an inner housing 270, an eyepiece group 520, and an adjusting knob 720 that are connected according to some embodiments of this specification. As shown in FIG. 13, the guide pillar 521 of the eyepiece group 520 may pass through the moving slot 277 and the guide slot 722-3, thereby achieving the moving connection of the eyepiece group 520 with the inner housing 270 along the optical axis, as well as the sliding connection of the eyepiece group 520 with the adjusting knob 720 along the guide slot 722-3.

When the toggle 724 is turned, the adjusting knob 720 rotates relative to the inner housing 270 about the optical axis of the eyepiece group 520, thereby driving the guide pillar 521 to move between the third limiting portion 722-31 and the fourth limiting portion 722-33. Moreover, since the guide pillar 521 passes through the moving slot 277, the guide pillar 521 also moves between the first limiting portion 277-1 and the second limiting portion 277-3 along the optical axis while moving between the third limiting portion 722-31 and the fourth limiting portion 722-33. Meanwhile, since the guide pillar 521 is disposed on the eyepiece group 520, when the guide pillar 521 moves along the optical axis, the eyepiece group 520 also moves along the optical axis, thereby achieving diopter adjustment.

FIG. 14 illustrates a front view of a measurement device 001 according to some embodiments of this specification. FIG. 15 illustrates a sectional view of FIG. 14 taken along section B-B. As shown in FIG. 14 and FIG. 15, an outer surface of the second end 220 of the outer housing 250 is provided with a recessed portion 252. The recessed portion 252 is recessed along the optical axis of the eyepiece group 520. In the operating state of the measurement device 001, the recessed portion 252 is located below the adjusting knob 720. The operating state is as described above and will not be repeated here.

A portion of the outer housing 250 between the recessed portion 252 and the adjusting knob 720 is provided with a notch 254. The toggle 724 may pass through the notch 254 and be located within the recessed portion 252. In this case, the design of the recessed portion 252 can further reduce the possibility of accidentally touching the toggle 724.

In some embodiments, to allow the measurement device 001 to be attached to a surface of an object, thereby simply and conveniently achieving placement and fixation of the measurement device 001, the measurement device 001 may further include a first magnetic assembly 300A.

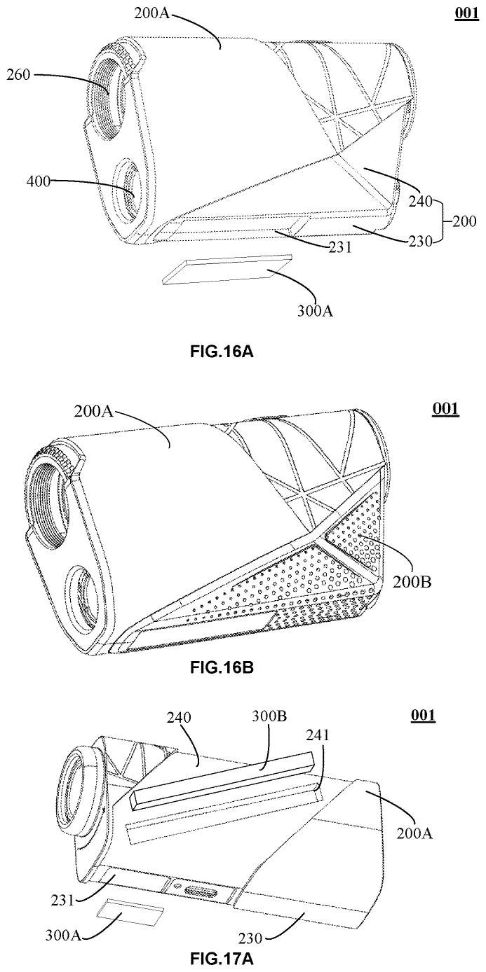

FIG. 16A illustrates a structural schematic diagram of a measurement device 001 having a first magnetic assembly 300A mounted thereon according to some embodiments of this specification. FIG. 16B illustrates a structural schematic diagram of a measurement device 001 having an auxiliary shell 200B mounted on a bottom 230 thereof according to some embodiments of this specification.

The first magnetic assembly 300A may be located at the bottom 230 of the housing 200. For example, the first magnetic assembly 300A may be located on the bottom 230 of the outer housing 250 (reference numeral not shown). The first magnetic assembly 300A enables the measurement device 001 to be attached via the bottom 230 to a surface of a ferromagnetic object. Here, the ferromagnetic object refers to an object containing iron, nickel, or the like that can be magnetically attracted. For example, because a golf course is large, users often need to take a golf cart when moving to the next shot. The surface of the object may be the body surface of the golf cart. For example, it may be a steel surface of the top support bar of the golf cart, the sidewall of the golf cart body, or the like. For another example, some users' golf bags have ferromagnetic regions on their surfaces, such as steel internal supports. In this case, the surface of the object may be the ferromagnetic region of the golf bag. By providing the first magnetic assembly 300A at the bottom 230 of the housing 200, when the user is not using the measurement device 001, the measurement device 001 may be attached to the surface of the object. Thus, the burden of the user is reduced, and the fixation of the placement position of the measurement device 001 can be ensured. Moreover, compared with other methods such as using slots, snaps, and adhesives, using magnetic attraction to fix the measurement device 001 is simple and quick to operate. Besides, such a structure may be simple, reusable, and inexpensive.

In some embodiments, the first magnetic assembly 300A may include a single magnetic element. In some other embodiments, the first magnetic assembly 300A may alternatively include a plurality of magnetic elements. For example, the first magnetic assembly 300A includes four magnetic elements. This specification does not limit the number of magnetic elements.

In some embodiments, the first magnetic assembly 300A may be a permanent magnet, such as one or more permanent magnets and a material made from permanent magnetic powder. A permanent magnet can retain its magnetic strength permanently.

When the first magnetic assembly 300A is a permanent magnet, it can operate without a power supply, thereby reducing energy consumption. Moreover, permanent magnets are small in size and occupy less space, making them more suitable for the lightweight and portable measurement device 001. In some other embodiments, the first magnetic assembly 300A may alternatively be an electromagnet, such as an element composed of one or more electromagnets. The electromagnet may have a conventional power supply, a switch control assembly, and an electromagnetic coil structure, which are not specifically limited in this specification. Those skilled in the art can easily find relevant literature by searching among existing technical materials. The electromagnet can gain or lose its magnetism depending on the supply of electric current. When the first magnetic assembly 300A is an electromagnet, the measurement device 001 may be correspondingly provided with a switch control component for controlling the first magnetic assembly 300A. With the switch control component, not only can the presence or absence of magnetism of the first magnetic assembly 300A be controlled, but also the magnetic strength of the first magnetic assembly 300A can be controlled, allowing for adaptation to more usage scenarios and situations. Thus, when the measurement device 001 is being used by a user, the power supply of the electromagnet can be turned off so that the measurement device 001 is in a non-magnetic state. After the user finishes using the measurement device 001, the power supply of the electromagnet can be turned on to generate magnetism, facilitating the user to conveniently place the device at hand. When the first magnetic assembly 300A is an electromagnet, its magnetic pull can be controlled. Moreover, the magnetism of the electromagnet can be adjusted by electric current, achieving a greater magnetic pull (i.e., stronger attraction) than a permanent magnet, thereby enabling the measurement device 001 to be attached more securely to the surface of an object.

To avoid interference between the first magnetic assembly 300A and other components inside the housing 200, the first magnetic assembly 300A may be placed in an accommodating cavity. In some embodiments, the bottom 230 of the housing 200 may be provided with a first accommodating cavity 231. The first magnetic assembly 300A may be placed in the first accommodating cavity 231. To better illustrate the first accommodating cavity 231 and the first magnetic assembly 300A, in FIG. 16A, the first magnetic assembly 300A is not shown inside the first accommodating cavity 231. In an actual product, the first magnetic assembly 300A is located within the first accommodating cavity 231.

The shape of the first accommodating cavity 231 may be adapted to fit the shape of the first magnetic assembly 300A, thereby avoiding space waste due to dimensional mismatch and ensuring a more compact assembly of the two. For example, when the first magnetic assembly 300A is a circular magnet, the first accommodating cavity 231 may be a matching cylindrical space. By placing the first magnetic assembly 300A in the first accommodating cavity 231, edge collisions can be avoided. For another example, as shown in FIG. 16A, when the first magnetic assembly 300A is a rectangular magnet, the first accommodating cavity 231 may be a matching prismatic space. After the first magnetic assembly 300A is placed in the first accommodating cavity 231, it is less likely to rotate. As shown in FIG. 16A, when the first accommodating cavity 231 is a prismatic space, the extended space of the bottom 230 of the housing 200 can be fully utilized, making the prismatic space larger for accommodating a larger rectangular magnet, so that the measurement device 001 can be attached more securely to the surface of an object. In some embodiments, the first magnetic assembly 300A may be flush with the opening of the first accommodating cavity 231. In some embodiments, the first magnetic assembly 300A may be lower than the opening of the first accommodating cavity 231, thereby preventing other components from contacting the first magnetic assembly 300A and affecting its magnetism.

In some embodiments, the first accommodating cavity 231 may be a recess formed from the inner wall to the outer wall of the housing at the bottom 230. In other words, the first accommodating cavity 231 is located on and faces the inside of the housing 200. In some other embodiments, the first accommodating cavity 231 may be a recess formed from the outer wall to the inner wall of the housing at the bottom 230, as shown in FIG. 16A. In other words, the first accommodating cavity 231 is located on and faces the outside of the housing 200. In this case, the first magnetic assembly 300A may be placed into the first accommodating cavity 231 from the outside, facilitating mounting and replacement of the first magnetic assembly 300A.

The first magnetic assembly 300A may be connected to the first accommodating cavity 231 via a connecting piece to fix the first magnetic assembly 300A within the first accommodating cavity 231 such that it does not fall out. For example, the connecting piece may be glue. The first magnetic assembly 300A may be bonded within the first accommodating cavity 231 by glue. For another example, the connecting piece may be a snap-fit structure. The first magnetic assembly 300A is provided with one of a slot and a snap. The first accommodating cavity 231 is internally provided with the other of a slot and a snap. The first magnetic assembly 300A and the first accommodating cavity 231 are connected via the snap-fit structure, such that the first magnetic assembly 300A does not fall out of the first accommodating cavity 231.

To ensure the aesthetic appeal and design quality of the product, the measurement device 001 may further include a cover structure for covering the first accommodating cavity 231. In some embodiments, as shown in FIG. 16B, the housing 200 may include a main shell 200A and an auxiliary shell 200B. For example, the outer housing 250 (reference numeral not shown) may include a main shell 200A and an auxiliary shell 200B.

The auxiliary shell 200B may be mounted on the main shell 200A and cover the recess. That is, after the auxiliary shell 200B is mounted on the main shell 200A, it may cover the first accommodating cavity 231.

The main shell 200A and the auxiliary shell 200B may be fixedly connected or detachably connected, thereby forming the appearance of the measurement device 001 as shown in FIG. 16B. In some embodiments, the auxiliary shell 200B may be located outside the main shell 200A. For example, an outer surface of the main shell 200A may be provided with a mounting groove. The shape of the auxiliary shell 200B matches the mounting groove. After the auxiliary shell 200B is mounted on the main shell 200A via the mounting groove, the upper surface of the auxiliary shell 200B is flush with the upper surface of the main shell 200A, so that the product maintains its aesthetics while being easy for the user to hold. The assembly method and assembly configuration of the auxiliary shell 200B and the main shell 200A can be varied according to product requirements and user preferences, and are not limited in this specification.

As shown in FIG. 16B, by using the auxiliary shell 200B to cover the first accommodating cavity 231, it is possible to prevent the first magnetic assembly 300A from falling out when the connecting piece does not secure the first magnetic assembly 300A firmly enough. For example, when the first magnetic assembly 300A is bonded to the first accommodating cavity 231 by glue and the glue fails, since the auxiliary shell 200B covers the first accommodating cavity 231, the first magnetic assembly 300A will not fall out of the measurement device 001. In some embodiments, as shown in FIG. 16B, the auxiliary shell 200B may cover part of the bottom 230 and a side portion 240 of the main shell 200A.

In some embodiments, the auxiliary shell 200B is mounted on the main shell 200A and at least partially covers the bottom, and the auxiliary shell 200B is magnetic, i.e., serves as the first magnetic assembly 300A. In other words, the auxiliary shell 200B not only functions as a housing but also has the capability to be attached to the surface of an object. When the auxiliary shell 200B is used as the first magnetic assembly 300A, it is no longer necessary to separately provide an accommodating cavity at the bottom 230, thereby simplifying the manufacturing process. Moreover, when the auxiliary shell 200B serves as the first magnetic assembly 300A, the first magnetic assembly 300A can cover the bottom 230 to the greatest extent, so that the measurement device 001 can be attached more securely to the surface of an object. When the main shell 200A and the auxiliary shell 200B are detachably connected, by using the auxiliary shell 200B as the first magnetic assembly 300A such that the magnetic assembly 300A is disposed externally, it is convenient for users to mount and remove the first magnetic assembly 300A according to their own needs. When the user is playing golf, the auxiliary shell 200B is mounted.

When the user is not playing golf, the auxiliary shell 200B is removed.

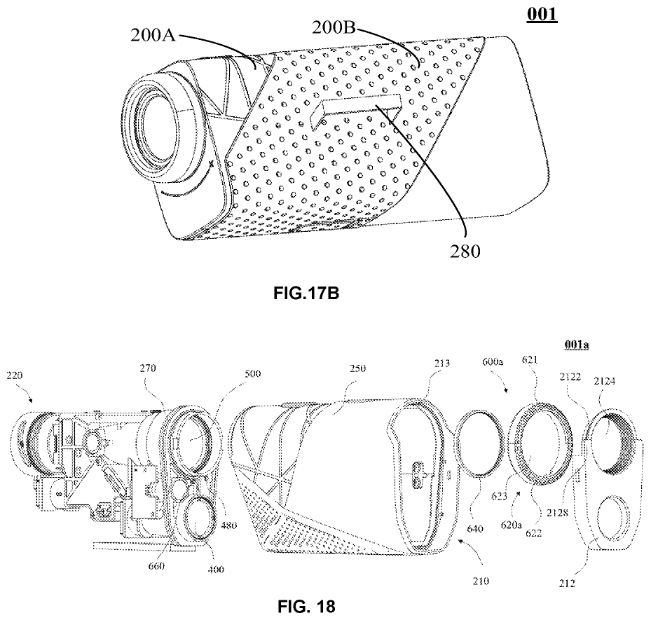

FIG. 17A illustrates a structural schematic diagram of a measurement device 001 having magnetic assemblies mounted on a bottom 230 and a side 240 according to some embodiments of this specification. FIG. 17B illustrates a structural schematic diagram of a measurement device 001 having auxiliary shells 200B mounted on a bottom 230 and a side 240 according to some embodiments of this specification.

In addition to the structure described above, a second magnetic assembly 300B may be disposed on the side portion 240 of the housing 200, so that the measurement device 001 can also be attached via the side portion 240 to the surface of a ferromagnetic object. For example, the second magnetic assembly 300B may be disposed on the side portion of the main shell 200A. By providing the magnetic assemblies on both the bottom 230 and the side portion 240, it can be ensured that the measurement device 001 can be attached to the surface of an object regardless of whether the user places it upright or on its side. The side portion 240 may include a first side portion and a second side portion disposed opposite the first side portion. Therefore, the second magnetic assembly 300B may be disposed on the first side portion or the second side portion. The second magnetic assembly 300B may alternatively be disposed on both the first side portion and the second side portion.

In some embodiments, the second magnetic assembly 300B may include a single magnetic element. In some other embodiments, the second magnetic assembly 300B may alternatively include a plurality of magnetic elements. For example, the second magnetic assembly 300B includes two magnetic elements. This specification does not limit the number of magnetic elements.

Similar to the first magnetic assembly 300A, the second magnetic assembly 300B may be a permanent magnet or an electromagnet, which will not be described redundantly here.

In some embodiments, to avoid interference between the second magnetic assembly 300B and other components inside the housing 200, the side portion 240 may alternatively include a second accommodating cavity 241, and the second magnetic assembly 300B is placed in the second accommodating cavity 241. To better illustrate the second accommodating cavity 241 and the second magnetic assembly 300B, in FIG. 17A, the second magnetic assembly 300B is not shown inside the second accommodating cavity 241. In an actual product, the second magnetic assembly 300B is located within the second accommodating cavity 241.

Similar to the first accommodating cavity 231 and the first magnetic assembly 300A, the shape of the second accommodating cavity 241 may be adapted to fit the shape of the second magnetic assembly 300B, thereby avoiding space waste due to dimensional mismatch and ensuring a more compact assembly. For specific design details, reference may be made to the first accommodating cavity 231 and the first magnetic assembly 300A, which will not be described redundantly here.

Similar to the first accommodating cavity 231, the second accommodating cavity 241 may be a recess formed from the inner wall to the outer wall of the housing at the side portion 240. In other words, the second accommodating cavity 241 is located on and faces the inside of the housing 200. In some other embodiments, the second accommodating cavity 241 may be a recess formed from the outer wall to the inner wall of the housing at the side portion 240, as shown in FIG. 17A. In other words, the second accommodating cavity 241 is located on and faces the outside of the housing 200. In this case, the second magnetic assembly 300B may be placed into the second accommodating cavity 241 from the outside, facilitating mounting and replacement of the second magnetic assembly 300B.

In this case, the second magnetic assembly 300B may be connected to the second accommodating cavity 241 via a connecting piece to fix the second magnetic assembly 300B within the second accommodating cavity 241 such that it does not fall out. The connection manner of the second magnetic assembly 300B and the second accommodating cavity 241 may refer to the connection manner of the first magnetic assembly 300A and the first accommodating cavity 231, which will not be described redundantly here.

Since the side portion 240 of the measurement device 001 has a large area, a plurality of magnetic elements may be disposed on the side portion 240, so that the measurement device 001 can be attached more securely to the surface of an object. In some embodiments, the second magnetic assemblies 300B may be disposed in the entire area of the side portion 240. In some other embodiments, the second magnetic assemblies 300B are distributed along the diagonal of the side portion 240. As shown in FIG. 17A, the second accommodating cavity 120 extends along the diagonal of the side portion 240. A rectangular magnetic member is placed in the second accommodating cavity 241. Since the second accommodating cavity 241 extends along the diagonal of the side portion 240 and the second magnetic assemblies 300B are distributed along the diagonal, a side of the measurement device 001 can be entirely attached to the surface of an object, thereby ensuring that the measurement device 001 does not easily fall off the surface of the object.

As shown in FIG. 17B, when the side of the measurement device 001 includes the second magnetic assembly 300B, the auxiliary shell 200B may be correspondingly designed to surround the main shell 200A. In this case, the auxiliary shell 200B not only covers the first accommodating cavity 231 but also covers the second accommodating cavity 241. The auxiliary shell 200B both ensures that the first magnetic assembly 300A and the second magnetic assembly 300B do not fall off the measurement device 001 and conceals the magnetic assemblies, making the product appearance more aesthetically pleasing.

Of course, the auxiliary shell 200B may alternatively include the second magnetic assembly 300B. In this case, since the second magnetic assembly 300B is located on the auxiliary shell 200B, the main shell 200A does not necessarily need to be provided with the second accommodating cavity 241.

As described previously, in some embodiments, the measurement device 001 may further include a hand-held portion 280. As shown in FIG. 17B, the side portion 240 of the housing 200 may be provided with the hand-held portion 280. Specifically, the side portion of the auxiliary shell 200B may be provided with the hand-held portion. By providing the hand-held portion 280, it is convenient for the user to remove the measurement device 001 from the surface of an object. Especially when the second magnetic assembly 300B is disposed on one side portion 240 of the measurement device 001, the hand-held portion 280 may be disposed on another side portion, thereby facilitating the user's grip. The hand-held portion 280 may be designed to match the size of the user's hand. The shape of the hand-held portion 280 may be designed to be ergonomic. This specification does not impose limitations in this regard.

In some embodiments, the measurement device 001 may further have a slope measurement function. Slope measurement can measure the slope of a target object (e.g., a hole) relative to the laser measurement device. Based on the straight-line distance to the target object and the slope, the laser measurement device may compensate the distance to the target object to obtain a compensated distance, and provide the compensated distance to the user. The user may then calculate the swing angle and force based on the compensated distance.

To facilitate user operation, the measurement device 001 may be equipped with a slope measurement switch for controlling the enabling and disabling of the slope measurement function. When the measurement device 001 is in use, the user or a viewer can determine whether the slope measurement function of the measurement device 001 is enabled by viewing the slope measurement switch.

Therefore, in some embodiments, as shown in FIG. 1, the measurement device 001 may further include a switch assembly 600. The switch assembly 600 may be mounted on the first end 210.

As shown in FIG. 1, the switch assembly 600 may include a switch key 620. The switch key 620 may be movably connected to the first end 210. The switch key 620 may control the enabling and disabling of the slope measurement of the measurement assembly 400. The switch key 620 may move between a first position and a second position. When the switch key 620 is in the first position, the slope measurement of the measurement assembly 400 is enabled. When the switch key 620 is in the second position, the slope measurement of the measurement assembly 400 is disabled. In the operating state of the measurement device 001, when the switch key 620 is in the first position, the switch key 620 is exposed outside the housing 200 at least in observation directions of a front viewing angle, a left viewing angle, and a right viewing angle. In this case, the user or viewer can view the switch key 620 at least in the observation directions of the front viewing angle, the left viewing angle, the right viewing angle, viewing angles between the front viewing angle and the left viewing angle, and viewing angles between the front viewing angle and the right viewing angle, thereby clearly knowing whether the switch key 620 is in an on state or an off state. In some embodiments, to further facilitate viewing by the user or viewer, a color of a portion of the switch key 620 exposed outside the housing 200 is different from that of the housing 200. The user and the viewer can quickly determine the position of the switch key 620 by its color, and thus know whether the switch key 620 is turned on. It should be noted that the operating state of the measurement device 001 may refer to the attitude of the measurement device 001 in use. In the operating state of the measurement device 001, the front viewing angle includes an angle of viewing from a receiving direction 2 of laser light. The left viewing angle and the right viewing angle are viewing angles determined relative to the front viewing angle. In some embodiments, the switch key 620 is exposed outside the housing 200 at least in the observation directions of the front viewing angle, the left viewing angle, and the right viewing angle. It may also be possible that the switch key 620 is exposed outside the housing 200 in the observation directions of the front viewing angle, the left viewing angle, the right viewing angle, and a top viewing angle. The top viewing angle is also a viewing angle determined relative to the front viewing angle.

The movable connection between the switch key 620 and the first end 210 may include a plurality of forms. For example, the movable connection may be a rotary connection. For another example, the movable connection may be a moving connection. The movable connection may alternatively be other forms of connection, such as a helical connection. Next, the switch assembly 600 is further described by taking as an example that the movable connection is the rotary connection.

FIG. 18 illustrates an exploded view of a measurement device 001a according to some embodiments of this specification. For ease of illustration, the laser measurement device shown in FIG. 18 is referred to as measurement device 001a. The switch assembly in the measurement device 001a is designated by 600a, and the switch key is designated by 620a. It should be noted that the measurement device 001a may be the measurement device 001 described above and have all or part of the structures of the measurement device 001 shown in FIG. 1 to FIG. 17.

As shown in FIG. 18, the housing 200 may include an inner housing 270 and an outer housing 250. As described previously, the housing 200 may include a first end 210 and a second end 220. The first end 210 may include an exit end cap 212. The exit end cap 212 may be in fixed connection with the outer housing 250, or may be in fixed connection with the inner housing 270, or may be in fixed connection with both the outer housing 250 and the inner housing 270. As shown in FIG. 18, the description will be made by taking as an example that the exit end cap 212 is in fixed connection with the outer housing 250. The fixed connection between the exit end cap 212 and the outer housing 250 includes, but is not limited to, integrated molding, threaded connection, adhesive bonding, riveting, welding, snap-fit connection, mortise-and-tenon connection, etc. The fixed connection between the exit end cap 212 and the outer housing 250 shown in FIG. 18 is a snap-fit connection.

As shown in FIG. 18, a limiting block 213 may be further disposed on the first end 210 of the housing 200. The limiting block 213 may be configured to limit the motion of the switch key 620a. The limiting block 213 may be disposed on the outer housing 250 or on the inner housing 270.

As shown in FIG. 18, the measurement assembly 400 may further include a slope trigger sensor 480. The slope trigger sensor 480 may control the enabling and disabling of the slope measurement function. The slope trigger sensor 480 is mounted at the first end 210 and located inside the housing 200, and is disposed opposite the switch key 620a. When the switch key 620a is in the first position, an enabling signal of the slope trigger sensor 480 is triggered such that the slope measurement is enabled. When the switch key 620a is in the second position, a disabling signal of the slope trigger sensor 480 is triggered such that the slope measurement is disabled.

The slope trigger sensor 480 may be a proximity sensor (also referred to as a non-contact travel switch) that can detect the proximity of a corresponding trigger structure without contacting it. Specifically, the slope trigger sensor 480 may be a magnetic inductive switch sensor, which triggers the enabling and disabling of the slope measurement by detecting changes in magnetic field, such as a reed switch sensor or a Hall effect switch sensor. The slope trigger sensor 480 may be a photoelectric switch sensor, which uses beam interruption or reflection to achieve switching actions, such as a through-beam photoelectric switch sensor or a diffusely reflective photoelectric switch sensor. The slope trigger sensor 480 may be an ultrasonic switch sensor that can determine the presence or a distance of an object based on changes in ultrasonic propagation time or echo intensity. The slope trigger sensor 480 may alternatively be a capacitive proximity switch, where the capacitance value changes when a trigger structure approaches, thereby triggering the switch.

As shown in FIG. 18, the switch assembly 600a may include the switch key 620a. In some embodiments, the switch assembly 600a may further include an axial locating piece 640. In some embodiments, the switch assembly 600a may further include a locking mechanism 660 and a locking slot (not shown in FIG. 18). The switch key 620a may be in rotary connection with the first end 210. The axial locating piece 640 may be configured to axially position the switch key 620a, preventing the switch key 620a from moving axially relative to the first end 210. The locking mechanism 660 and the locking slot may be respectively provided on the housing 200 and the switch key 620a to achieve locking of the switch key 620a. Specifically, the locking mechanism 660 and the locking slot may be respectively provided on the outer housing 250 and the switch key 620a, or may be respectively provided on the inner housing 270 and the switch key 620a. For ease of description, the following description will be made by taking as an example that the locking mechanism 660 is provided on the inner housing 270, while the locking slot is provided on the switch key 620a.

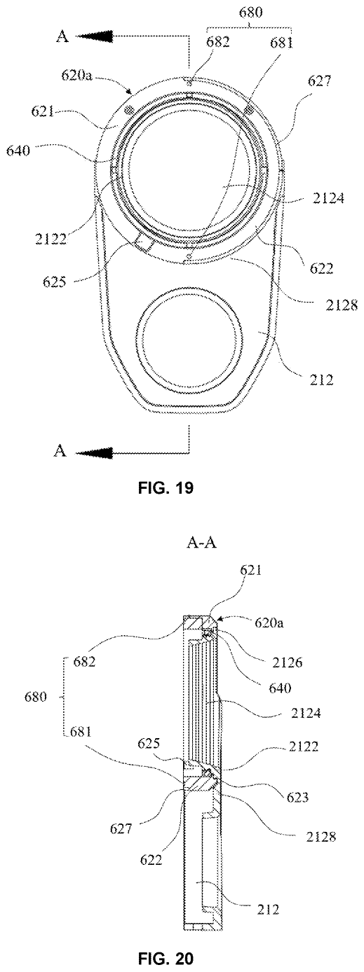

FIG. 19 illustrates a rear view of a switch key 620a and an exit end cap 212 that are connected according to some embodiments of this specification. FIG. 20 illustrates a sectional view A-A of FIG. 19. As shown in FIG. 18 to FIG. 20, the switch key 620a may be in rotary connection with the first end 210. A direction of a rotation axis of the rotary connection is the direction of the front viewing angle. Specifically, the switch key 620a may be in rotary connection with the exit end cap 212 of the first end 210.

The exit end cap 212 may include a mounting shaft 2122. The mounting shaft 2122 is configured for rotary connection with the switch key 620a. A direction of a rotation axis of the mounting shaft 2122 is the direction of the front viewing angle. The mounting shaft 2122 may include a through hole 2124. When the measurement device 001a operates, the laser light may pass through the through hole 2124. One end of the mounting shaft 2122 may further include a shaft shoulder 2126. The shaft shoulder 2126 may be disposed at the end of the mounting shaft 2122 close to the outside of the housing 200. The shaft shoulder 2126 may abut against one side of the switch key 620a (e.g., the side of the switch key 620a facing the outside of the housing 200), and the axial locating piece 640 may be fixedly connected to the mounting shaft 2122 and abut against another side of the switch key 620a (e.g., the side of the switch key 620a facing the inside of the housing 200), so that the switch key 620a is axially fixed relative to the mounting shaft 2122. The axial locating piece 640 and the mounting shaft 2122 may be fixedly connected via screw thread, or may be clamped via a clamping slot, etc.

The exit end cap 212 may further include a shielding portion 2128. The shielding portion 2128 may be fixedly connected to the mounting shaft 2122. The shielding portion 2128 may be located on a side of the mounting shaft 2122 away from the inside of the housing 200. The shielding portion 2128 protrudes in a radial direction of the mounting shaft 2122 relative to the mounting shaft 2122, so as to shield the mounting shaft 2122. In some embodiments, the angle of a sector region formed by the protruding part of the shielding portion 2128 in the radial direction of the mounting shaft 2122 and the central axis of the mounting shaft 2122 is not less than 180 degrees. That is, in the radial direction of the mounting shaft 2122, the shielding portion 2128 shields at least half of the mounting shaft 2122.

The switch key 620a may include a mounting hole 623. The mounting hole 623 may be in rotary connection with the mounting shaft 2122, thereby achieving the rotary connection of the switch key 620a with the first end 210. The shape and size of the mounting hole 623 match those of the mounting shaft 2122. In some embodiments, the size of the mounting hole 623 may be larger than that of the mounting shaft 2122, so that the switch key 620a can rotate relative to the mounting shaft 2122. Steps may be provided on both sides of the mounting hole 623 to respectively abut against the shaft shoulder 2126 and the axial locating piece 640.

The switch key 620a may include a first portion 621 and a second portion 622. When the switch key 620a is rotated to the first position, the slope measurement is enabled. In this case, the first portion 621 of the switch key 620a is exposed outside the housing 200 in the observation directions of the front viewing angle, the left viewing angle, the right viewing angle, and the top viewing angle. The second portion 622 of the switch key 620a is located on the side of the shielding portion 2128 facing the inside of the housing 200. That is, the shielding portion 2128 shields the second portion 622 such that the second portion 622 is located inside the housing 200. To allow the user or viewer to quickly identify the color of the first portion 621, the color of the first portion 621 may be set to a high-saturation color, such as bright red, bright yellow, and emerald green. Moreover, the color of the first portion 621 is different from that of the housing 200, so as to facilitate quick distinguishing between the first portion 621 and the housing 200. For example, the saturation of the color of the first portion 621 is significantly different from that of the housing 200, or the color of the first portion 621 and that of the housing 200 are opposite colors on the color wheel. Since the color of the first portion 621 is different from and highly contrasting with that of the housing 200, the color of the first portion 621 is eye-catching. When the first portion 621 is exposed outside the housing 200, the user or viewer can easily view the first portion 621 of the switch key 620a from a plurality of different angles, thereby quickly determining that the switch key 620a is in the first position and the slope measurement is in the on state.

Similarly, when the switch key 620a is rotated to the second position, the slope measurement is disabled. In this case, the second portion 622 is exposed outside the housing 200 in the observation directions of the front viewing angle, the left viewing angle, the right viewing angle, and the top viewing angle. The first portion 621 is located on the side of the shielding portion 2128 facing the inside of the housing 200. That is, the shielding portion 2128 shields the first portion 621 such that the first portion 621 is located inside the housing 200. The color of the first portion 621 is different from that of the second portion 622. The difference in color may be a significant difference in color saturation. For example, the saturation of the color of the first portion 621 may be 70%-100%, while the saturation of the color of the second portion 622 may be 0%-30%. The different colors may be opposite colors on the color wheel. For example, the color of the first portion 621 may be yellow, while the color of the second portion 622 may be blue. Since the color of the second portion 622 is different from and highly contrasting with that of the first portion 621, when the second portion 622 is exposed outside the housing 200, the user or viewer can easily view the second portion 622 of the switch key 620a from a plurality of different angles, thereby quickly determining that the switch key 620a is in the second position and the slope measurement is in the off state. To further help the user or viewer quickly distinguish between the first portion 621 and the second portion 622, the color of the second portion 622 may be similar to that of the housing 200. When the switch key 620a is in the second position, the second portion 622 is exposed outside the housing 200. In this case, since the second portion 622 is similar in color to the housing 200, the color of the second portion 622 is inconspicuous relative to the housing 200, and the first portion 621 is hidden within the housing 200. Therefore, the user will not see the eye-catching first portion 621 and can also quickly determine that the switch key 620a is in the second position and the slope measurement is in the off state.

As described previously, the switch key 620a is in rotary connection with the exit end cap 212. To ensure that the first portion 621 is not exposed outside the housing 200 when the switch key 620a is in the second position, a rotation angle of the switch key 620a from the first position to the second position is not greater than 180 degrees. In some embodiments, the rotation angle of the switch key 620a from the first position to the second position may be equal to the angle of a sector region formed by the first portion 621 and the central axis of the switch key 620a. That is, when the switch key 620a is rotated from the first position to the second position, it rotates exactly by the size of one first portion 621. In this case, the angle of a sector region formed by the second portion 622 and the central axis of the switch key 620a is greater than or equal to that of the sector region formed by the first portion 621 and the central axis of the switch key 620a. In some embodiments, the angle of a sector region formed by the protruding part of the shielding portion 2128 in the radial direction of the mounting shaft 2122 and the central axis of the mounting shaft 2122 is consistent with that of a sector region formed by the central axis of the switch key 620a.

The switch key 620a is further provided with a trigger structure 625. The trigger structure 625 may be disposed on the side of the switch key 620a facing the inside of the housing 200, so as to be arranged opposite the slope trigger sensor 480. When the switch key 620a is in the first position, the trigger structure 625 is opposite to the slope trigger sensor 480. In this case, the enabling signal of the slope trigger sensor 480 is triggered such that the slope measurement is enabled. When the switch key 620a leaves the first position, the trigger structure 625 is moved away from the slope trigger sensor 480 and the disabling signal of the slope trigger sensor 480 is triggered such that the slope measurement is disabled.

Depending on the type of the slope trigger sensor 480, the trigger structure 625 may have a plurality of designs. For example, when the slope trigger sensor 480 is a magnetic inductive switch sensor, the trigger structure 625 may be a trigger permanent magnet, a trigger protrusion, a trigger groove, or the like. When the slope trigger sensor 480 is a photoelectric switch sensor, the trigger structure 625 may be a trigger reflector, a trigger through hole, a trigger protrusion, a trigger groove, or the like. When the slope trigger sensor 480 is an ultrasonic switch sensor, the trigger structure 625 may be a trigger protrusion, a trigger groove, or the like. Those skilled in the art will understand that other designs of the trigger structure 625 also fall into the protection scope of the present disclosure. The trigger protrusion may protrude in a direction toward the slope trigger sensor 480, and the trigger groove may be recessed in a direction away from the slope trigger sensor 480.

For instance, the slope trigger sensor 480 is a Hall sensor and the trigger structure 625 is a trigger groove. When the switch key 620a is in the first position, the trigger groove is opposite to the Hall sensor. In this case, the straight-line distance between the trigger groove and the Hall sensor is large, and the Hall sensor generates a first signal. The first signal is an enabling signal. When the switch key 620a leaves the first position, the trigger groove is moved away from the Hall sensor. In this case, the Hall sensor is opposite to the switch key 620a, the straight-line distance between the switch key 620a and the Hall sensor is small, and the Hall sensor generates a second signal. The second signal is a disabling signal.

The switch key 620a may further be provided with a limiting slot 627. The limiting slot 627 is distributed along the circumferential direction of the switch key 620a but does not cover the entire circumference of the switch key 620a. In some embodiments, the angle of a sector region formed by the limiting slot 627 and the central axis of the mounting shaft 2122 is not less than the rotation angle of the switch key 620a between the first position and the second position. The limiting block 213 may be slidably connected to the limiting slot 627. Specifically, when the switch key 620a is rotated, the limiting block 213 slides within the limiting slot 627, causing the switch key 620a to rotate between the first position and the second position.

To cause the switch key 620a to stay in the first position and the second position, the switch assembly 600a further includes a locking mechanism 660 and a locking slot 680.

The locking mechanism 660 may be mounted inside the housing 200 and face the switch key 620a. For example, the locking mechanism 660 may be mounted on the inner housing 270. The locking mechanism 660 may be an elastic body capable of extending and retracting along the direction of the rotation axis of the rotary connection. The locking slot 680 may be mounted on the switch key 620a and face the inside of the housing 220, so as to be opposite to the locking mechanism 660. The locking slot 680 may include a first locking slot 681 and a second locking slot 682. When the switch key 620a is rotated to the first position, the locking mechanism 660 snaps into the first locking slot 681. In this case, the switch key 620a stays in the first position. When the switch key 620a is rotated to the second position, the locking mechanism 660 snaps into the second locking slot 682. In this case, the switch key 620a stays in the second position.

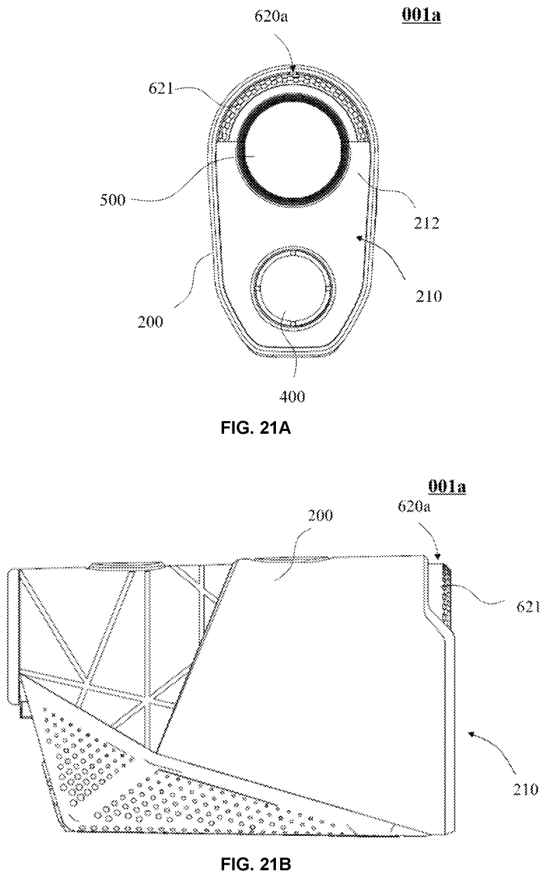

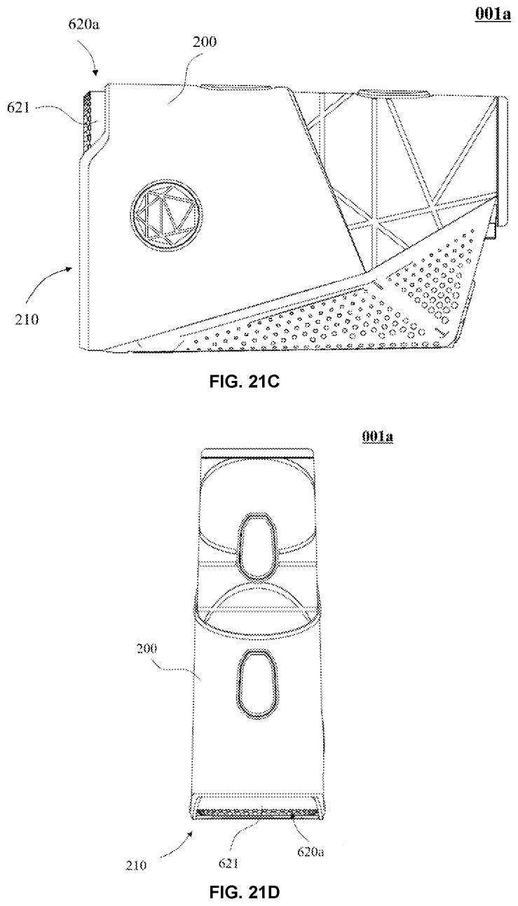

FIG. 21A illustrates a front view of a measurement device 001a in an operating state according to some embodiments of this specification. FIG. 21B illustrates a left view of a measurement device 001a in an operating state according to some embodiments of this specification. FIG. 21C illustrates a right view of a measurement device 001a in an operating state according to some embodiments of this specification. FIG. 21D illustrates a top view of a measurement device 001a in an operating state according to some embodiments of this specification. The switch key 620a in the measurement device 001a shown in FIG. 21A to FIG. 21D is in the first position. As shown in FIG. 21A to FIG. 21D, when the switch key 620a is rotated to the first position, the first portion 621 of the switch key 620a is exposed outside the housing 200 in the observation directions of the front viewing angle, the left viewing angle, the right viewing angle, and the top viewing angle. In this case, the second portion 622 of the switch key 620a is located inside the housing 200.

As described above, the movable connection may be a moving connection. Next, the switch assembly 600a will be further described by taking as an example that the movable connection is the moving connection.

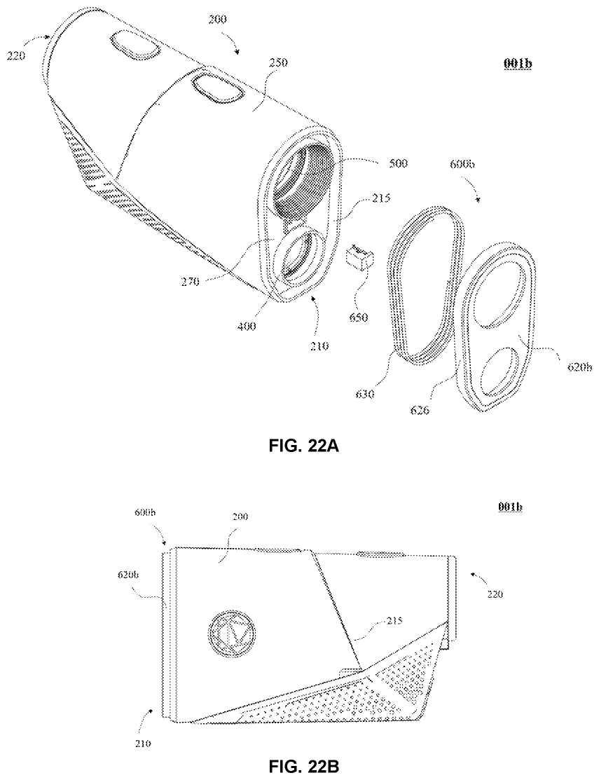

FIG. 22A illustrates an exploded view of a measurement device 001b according to some embodiments of this specification. FIG. 22B illustrates a right view of a measurement device 001b in an operating state with a switch key 620b in a first position according to some embodiments of this specification. For ease of illustration, the switch assembly in the measurement device 001b shown in FIG. 22A and FIG. 22B is designated by 600b, and the switch key is designated by 620b. As shown in FIG. 22A and FIG. 22B, the measurement assembly 400 and the telescope assembly 500 are as described above and will not be described redundantly here. As shown in FIG. 22A and FIG. 22B, the housing 200 may include an inner housing 270 and an outer housing 250. The inner housing 270 and the outer housing 250 are as described above and will not be described redundantly here.

The first end 210 may include a sliding slot 215 extending along the direction of the front viewing angle. The structure of the sliding slot 215 may be implemented in a plurality of ways. In some embodiments, the sliding slot 215 may be distributed along the circumferential direction of the first end 210 and extend along the direction of the front viewing angle. In some embodiments, the sliding slot 215 may be a plurality of slots arranged at intervals. The plurality of slots are uniformly distributed at any position on the first end 210 and extend along the direction of the front viewing angle. In some embodiments, the sliding slot 215 may be a slot provided near the center of the first end 210 and extending along the direction of the front viewing angle. For example, the sliding slot 215 may be provided at a position between a laser emitter and the telescope assembly 500. The sliding slot 215 in the measurement device 001b shown in FIG. 22A and FIG. 22B is distributed along the circumferential direction of the first end 210 and extends along the direction of the front viewing angle.

The switch key 620b may be in moving connection with the sliding slot 215 along the direction of the front viewing angle. Taking FIG. 22A and FIG. 22B for example, a sidewall 626 of the switch key 620b may be in moving connection with the sliding slot 215 along the direction of the front viewing angle. When the switch key 620b is in the first position, the switch key 620b protrudes outward relative to the housing 200. In this case, the switch key 620b is exposed outside the housing 200 at least in the observation directions of the front viewing angle, the left viewing angle, and the right viewing angle. In some embodiments, the switch key 620b may alternatively be exposed outside the housing 200 in the observation directions of a bottom viewing angle and the top viewing angle. In this case, the user and the viewer can see the switch key 620b at least in the observation directions of the front viewing angle, the left viewing angle, the right viewing angle, the viewing angles between the front viewing angle and the left viewing angle, and the viewing angles between the front viewing angle and the right viewing angle, thereby quickly determining that the switch key 620b is in the first position and the slope measurement is in the on state. To allow the user or viewer to quickly identify the color of the switch key 620b, the color of the switch key 620b may be set to a high-saturation color, such as bright red, bright yellow, and emerald green. Moreover, the color of the switch key 620b is different from that of the housing 200, so as to facilitate quick distinguishing between the switch key 620b and the housing 200. For example, the saturation of the color of the switch key 620b is significantly different from that of the housing 200, or the color of the switch key 620b and that of the housing 200 are opposite colors on the color wheel. Since the color of the switch key 620b is different from and highly contrasting with that of the housing 200, the color of the switch key 620b is eye-catching. When the switch key 620b is exposed outside the housing 200, the user or viewer can easily view the switch key 620a from a plurality of different angles.

When the switch key 620b is moved from the first position toward the inside of the housing 200 to the second position, the switch key 620b is not exposed outside the housing 200 in the observation directions of the left viewing angle and the right viewing angle. In this case, in the observation directions of the left viewing angle and the right viewing angle, the user and the viewer can quickly determine that the switch key 620b is in the second position and the slope measurement is in the off state.

The switch assembly 600b may further include an elastic piece 630. The elastic piece 630 may be located in the sliding slot 215. Two ends of the elastic piece 630 are connected to the sliding slot 215 and the switch key 620b, respectively. The elastic piece 630 may be a spring. Two ends of the spring may abut against the sliding slot 215 and the switch key 620b, respectively. The elastic piece 630 may provide a restoring force for the switch key 620b, enabling the switch key 620b to move from the second position to the first position. When the switch key 620b is in the first position and is pressed, the elastic piece 630 is compressed, and the switch key 620b is moved toward the inside of the housing 200 until the switch key 620b reaches the second position. When the switch key 620b is in the second position and is pressed, the elastic piece 630 is decompressed and returns to its original state, and the switch key 620b is moved toward the outside of the housing 200 until the switch key 620b reaches the first position.

The switch assembly 600b may further include a self-locking mechanism 650. The self-locking mechanism 650 is located between the switch key 620b and the first end 210, and may be connected to the first end 210 and the switch key 620b, respectively, such that the switch key 620b self-locks in the first position and the second position.

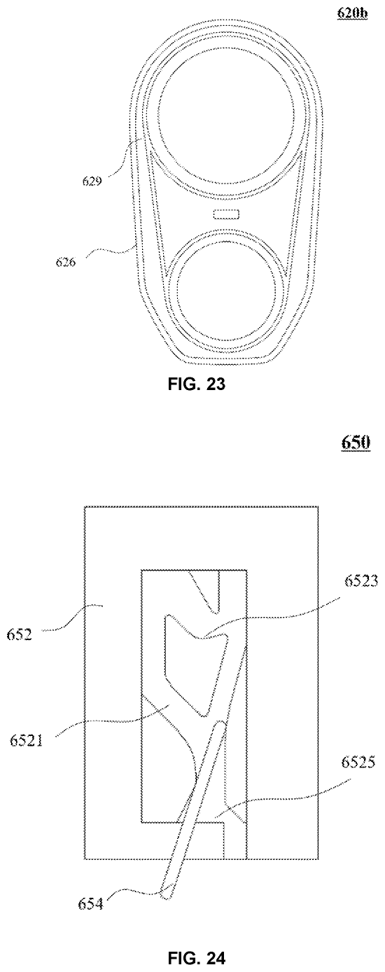

FIG. 23 illustrates a rear view of a switch key 620b according to some embodiments of this specification. As shown in FIG. 23, an accommodating cavity 629 is formed on a side of the switch key 620b facing the inside of the housing 200. The elastic piece 630 may be accommodated in the accommodating cavity 629.

FIG. 24 illustrates a top view of a self-locking mechanism 650 according to some embodiments of this specification. As shown in FIG. 24, the self-locking mechanism 650 may include a locking base 652 and a locking slide rod 654. The locking base 652 and the locking slide rod 654 are connected to the switch key 620b and the first end 210, respectively. For example, the locking base 652 is connected to the switch key 620b, while the locking slide rod 654 is connected to the first end 210. For another example, the locking base 652 is connected to the first end 210, while the locking slide rod 654 is connected to the switch key 620b.

The following description is made by taking as an example that the locking base 652 is connected to the switch key 620b, while the locking slide rod 654 is connected to the first end 210. The locking base 652 may be in fixed connection with the switch key 620b. There are a plurality of ways to achieve the fixed connection, such as integrated molding, threaded connection, welding, riveting, adhesive bonding, snap-fit connection, and mortise-and-tenon connection, which will not be limited in this specification. The locking base 652 faces the inside of the housing 200. The locking base 652 may be provided with a self-locking slot 6521. The self-locking slot 6521 may play a role in guiding the self-locking mechanism 650. The self-locking slot 6521 may be provided with a self-locking position 6523 and a limiting position 6525. The shape of the self-locking slot 6521 may be designed as needed, such as a rectangle, an ellipse, and a circle, which is not limited herein. The locking slide rod 654 has one end in rotary connection with the first end 210, and another end located in the self-locking slot 6521 and in sliding connection with the self-locking slot 6521. When the switch key 620b moves between the first position and the second position, the locking slide rod 654 moves between the self-locking position 6523 and the limiting position 6525.

When the switch key 620b is in the first position, the locking slide rod 654 is in the limiting position 6525. In this case, when the switch key 620b is pressed, the switch key 620b moves from the first position to the second position, the switch key 620b drives the locking base 652 to move toward the inside of the housing 200, and the locking slide rod 654 slides within the self-locking slot 6521 until it reaches the self-locking position 6523. In this case, the switch key 620b reaches the second position and self-locks. When the switch key 620b is in the second position and is pressed, the locking slide rod 654 is disengaged from the self-locking position 6523, and the switch key 620b moves in a direction away from the first end 210 under the action of the elastic force of the elastic piece 630 until the locking slide rod 654 reaches the limiting position 6525. In this case, the switch key 620b is in the first position and self-locks.

The self-locking mechanism 650 may be any structure that achieves self-locking of the switch key 620b by means of friction or other motion-resisting forces. For example, the self-locking mechanism 650 may be a snap-fit self-locking structure, which achieves locking and unlocking via the engagement between a tenon and a mortise. For example, the self-locking mechanism 650 may be a gear or gear-like self-locking structure, which achieves locking and unlocking by changing the position of the gear or gear-like structure or using other control structures, such as ratchet-pawl self-locking and worm gear self-locking. For another example, the self-locking mechanism 650 may be a friction-based self-locking mechanism, which utilizes friction to achieve locking and unlocking, such as threaded self-locking and bevel self-locking.

In conclusion, this specification provides a multi-mode laser measurement device 001 using a single photosensitive element. The measurement device 001 can achieve integrated high-accuracy short distance measurement and long distance measurement by emitting the first emitted laser beam and the second emitted laser beam, thereby meeting various measurement requirements. Moreover, both the first wavelength of the first emitted laser beam and the second wavelength of the second emitted laser beam fall within the sensing band of the single photosensitive element. Thus, by providing the single photosensitive element, the receiving module 430 can simultaneously receive the first reflected laser beam and the second reflected laser beam during operation, thereby reducing the internal space of the measurement device 001 occupied by distance measurement components.

The foregoing describes the specific embodiments of this specification. Other embodiments fall within the scope of the appended claims. In some cases, the actions or steps described in the claims may be performed in sequences different from those in the embodiments and still achieve expected results. In addition, the processes depicted in the accompanying drawings do not necessarily require the specific orders or sequential orders shown for achieving the expected results. In some implementations, multitasking and parallel processing are also possible or may be advantageous.

In summary, after reading this detailed disclosure, those skilled in the art can understand that the foregoing detailed disclosure may be presented by way of example only, and may not be limited. Although there is no clear description, those skilled in the art can understand that this specification intends to cover various reasonable changes, improvements, and modifications of the embodiments. These changes, improvements, and modifications are intended to be proposed in this specification and are within the spirit and scope of the exemplary embodiments of this specification.

In addition, some specific terms in this specification have been used to describe the embodiments of the utility model. For example, “one embodiment”, “an embodiment”, and/or “some embodiments” mean that a specific feature, structure, or characteristic described in combination with the embodiment may be included in at least one embodiment of this specification. Therefore, it can be emphasized and should be understood that two or more references to “an embodiment” or “one embodiment” or “an alternative embodiment” in various parts of this specification do not necessarily all refer to the same embodiment. In addition, specific feature, structure, or characteristic may be appropriately combined in one or more embodiments of this specification.

It should be understood that in the foregoing description of the embodiments of the present disclosure, to help understand a feature, and for the purpose of simplifying the present disclosure, the present disclosure sometimes combines various features in a single embodiment, a drawing, or description thereof. However, this does not mean that the combination of these features is necessary. It is entirely possible for those skilled in the art to extract some of the features as a single embodiment for understanding when reading the present disclosure. In other words, the embodiments in this specification can also be understood as an integration of a plurality of sub-embodiments. The content of each sub-embodiment is also true when it is less than all the characteristics of a single previously disclosed embodiment.

Each patent, patent application, patent application publication and other materials cited herein, such as articles, books, specifications, publications, documents, articles and the like, may be incorporated herein by reference. The entire content used for all purposes, except for any related litigation document history, may be inconsistent or conflicting with this document, or any identical litigation document that may have restrictive influence on the broadest scope of the claims' history. Those are associated with this document now or in the future. For example, if the description, definition, and/or use of terms in any associated materials contained herein is inconsistent with or in conflict with that in this document, the terms in this document shall prevail.

Finally, it should be understood that the embodiment of the utility model provided herein is an explanation of the principle of the embodiment of the utility model. Other modified embodiments are also within the scope of this specification. Therefore, the embodiments disclosed in this specification are merely examples rather than limitations. Those skilled in the art can adopt alternative configurations according to the embodiments in this specification to implement the utility model in this specification. Therefore, the embodiments of this specification are not limited to those exactly described in the utility model.

1. A multi-mode laser measurement device, comprising:
a housing comprising a first end and a second end; and
a laser measurement assembly mounted within the housing and comprising:
a first emitting module comprising a first emitter, wherein the first emitter is configured to emit a first emitted laser beam having a first wavelength to a target object during operation, and the first emitted laser beam is reflected by the target object into a first reflected laser beam;
a second emitting module comprising a second emitter, wherein the second emitter is configured to emit a second emitted laser beam having a second wavelength to the target object during operation, the second emitted laser beam is reflected by the target object into a second reflected laser beam, and the second wavelength is different from the first wavelength; and
a receiving module configured to, during operation, receive a reflected laser beam and measure a target distance between the laser measurement device and the target object based on the reflected laser beam, wherein
the reflected laser beam comprises the first reflected laser beam and/or the second reflected laser beam, and is received by the receiving module after passing through the first end; and
the receiving module comprises a photosensitive element configured to detect laser light of the first wavelength and the second wavelength during operation.

2. The laser measurement device according to claim 1, wherein the receiving module further comprises an optical receiving assembly;
the optical receiving assembly comprises a measuring incident end and a measuring exit end;
the photosensitive element is located at the measuring exit end; and
the first reflected laser beam of the first wavelength and the second reflected laser beam of the second wavelength enter the optical receiving assembly from the measuring incident end and then propagate along a same measuring optical path to the measuring exit end so as to enter the photosensitive element.

3. The laser measurement device according to claim 2, wherein the optical receiving assembly further comprises a viewing incident end and a viewing exit end;
ambient light enters the optical receiving assembly through the viewing incident end, propagates along a viewing optical path, and exits from the viewing exit end; and
the viewing optical path is different from the measuring optical path.

4. The laser measurement device according to claim 3, wherein
the optical receiving assembly comprises an objective lens group mounted at the first end, a beam splitting module, and an eyepiece group mounted at the second end and in moving connection with the second end along an optical axis of the eyepiece group;
the objective lens group serves as the measuring incident end and the viewing incident end, and the eyepiece group serves as the viewing exit end;
the beam splitting module is located between the objective lens group and the eyepiece group, and comprises a first incident end, a first exit end, and a second exit end;
the eyepiece group faces the first exit end;
the ambient light enters the beam splitting module through the objective lens group from the first incident end, propagates along the viewing optical path, exits the beam splitting module from the first exit end, and then enters the eyepiece group; and
the reflected laser beam enters the beam splitting module through the objective lens group from the first incident end, propagates along the measuring optical path, exits the beam splitting module from the second exit end, and finally enters the photosensitive element.

5. The laser measurement device according to claim 4, wherein the beam splitting module comprises:
a first prism comprising:
the first incident end configured to receive the ambient light and/or the reflected laser beam; and
a beam splitting surface configured to reflect the ambient light and transmit the reflected laser beam;
a second prism located between the first prism and the eyepiece group and comprising the first exit end, and configured to receive the ambient light exiting from the first prism and guide the ambient light to propagate along the viewing optical path, exit the beam splitting module from the first exit end, and then enter the eyepiece group; and
a third prism located between the first prism and the photosensitive element and comprising the second exit end, and configured to receive the reflected laser beam exiting from the first prism and guide the reflected laser beam to propagate along the measuring optical path, exit the beam splitting module from the second exit end, and finally enter the photosensitive element.

6. The laser measurement device according to claim 5, wherein the beam splitting module further comprises a second incident end; and
the laser measurement device further comprises:
a first display module located between the eyepiece group and the beam splitting module and configured to output a first display signal toward the eyepiece group during operation; and
a second display module configured to output a second display signal during operation, wherein the second display signal enters the beam splitting module from the second incident end, exits the beam splitting module from the first exit end, and then is output toward the eyepiece group.

7. The laser measurement device according to claim 4, further comprising:
an adjusting knob in rotary connection with the second end around the optical axis of the eyepiece group, wherein the adjusting knob is provided with a guide slot helically extending in a circumferential direction of the adjusting knob, and the eyepiece group is in sliding connection with the adjusting knob along the guide slot; and
when the adjusting knob is rotated, the adjusting knob drives the eyepiece group to move along the optical axis.

8. The laser measurement device according to claim 7, wherein the adjusting knob comprises:
a rotary connecting portion in rotary connection with the second end around the optical axis of the eyepiece group and comprising the guide slot, wherein the rotary connecting portion is covered by the housing; and
a toggle connected to the rotary connecting portion;
wherein the housing is provided with a notch; the toggle passes through the notch and is exposed outside the housing; and the rotary connecting portion is driven to rotate by turning the toggle;
wherein the toggle is disposed in a radial direction of the rotary connecting portion; an outer surface of the housing is provided with a recessed portion that is recessed along the optical axis; and the toggle passes through the notch and is located in the recessed portion.

9. The laser measurement device according to claim 8, wherein
in an operating state of the laser measurement device, the toggle is located below the rotary connecting portion; and/or
the housing comprises:
an inner housing comprising the second end;
an outer housing in fixed connection with the inner housing and covering the inner housing, wherein the outer housing comprises the recessed portion and the notch, and the rotary connecting portion is located between the inner housing and the outer housing; and
an end cap connected to the outer housing and covering the rotary connecting portion.

10. The laser measurement device according to claim 7, wherein
the second end comprises a connecting shaft; the adjusting knob comprises a connecting hole; the connecting shaft is in rotary connection with the connecting hole;
the connecting shaft comprises an eyepiece hole in which the eyepiece group is mounted; the connecting shaft is provided with a penetrating moving slot that extends along the optical axis; a guide pillar is disposed on the eyepiece group, and passes through the moving slot to achieve a moving connection of the eyepiece group with the second end along the optical axis;
the guide pillar passes through the guide slot to achieve a sliding connection of the eyepiece group with the adjusting knob along the guide slot; and
the moving slot comprises a first limiting portion and a second limiting portion; the guide pillar is configured to move between the first limiting portion and the second limiting portion; the guide slot comprises a third limiting portion and a fourth limiting portion; and
when the guide pillar abuts against the first limiting portion or the second limiting portion, the guide pillar is located between the third limiting portion and the fourth limiting portion.

11. The laser measurement device according to claim 1, wherein
the first emitted laser beam is continuous laser light, and the receiving module is configured to measure the target distance based on the first reflected laser beam by a phase distance measurement method or a high-speed pulse phase distance measurement method; the second emitted laser beam is pulsed laser light, and the receiving module is configured to measure the target distance based on the second reflected laser beam by a time-of-flight distance measurement method; and/or
the laser measurement device is configured to operate in a first mode or a second mode or in both the first mode and the second mode; in the first mode, the first emitting module operates, the photosensitive element detects the first reflected laser beam, and the receiving module measures the target distance based on the first reflected laser beam; in the second mode, the second emitting module operates, the photosensitive element detects the second reflected laser beam, and the receiving module measures the target distance based on the second reflected laser beam, wherein the first mode is a short distance measurement mode, and a corresponding measurement range of the target distance is from 0 m to 50 m; the second mode is a long distance measurement mode, and a corresponding measurement range of the target distance is greater than 50 m; and/or
the first emitting module further comprises a first lens group, and the first emitted laser beam is incident on the target object via the first lens group to collimate the first emitted laser beam; and/or
the second emitting module further comprises a second lens group, and the second emitted laser beam is incident on the target object via the second lens group to collimate the second emitted laser beam.

12. The laser measurement device according to claim 1, further comprising:
a first magnetic assembly located at a bottom of the housing and enabling the laser measurement device to be attached via the bottom to a surface of a ferromagnetic object.

13. The laser measurement device according to claim 12, wherein
the bottom comprises a first accommodating cavity in which the first magnetic assembly is placed; the first accommodating cavity is a recess formed on an outer side of the bottom; the first magnetic assembly is connected to the first accommodating cavity via a connecting piece; the housing comprises a main shell and an auxiliary shell that is mounted on the main shell and covers the recess; and/or
the housing comprises the main shell and the auxiliary shell that is mounted on the main shell and at least partially covers the bottom, wherein the auxiliary shell is magnetic and serves as the first magnetic assembly.

14. The laser measurement device according to claim 1, wherein
the laser measurement assembly is further configured to measure a slope between the laser measurement device and the target object;
the laser measurement device further comprises: a switch assembly that is mounted at the first end and comprises a switch key movably connected to the first end, wherein when the switch key is in a first position, the laser measurement assembly is enabled for slope measurement; and when the switch key is in a second position, the laser measurement assembly is disabled for slope measurement; and
in an operating state of the laser measurement device, when the switch key is in the first position, the switch key is exposed outside the housing in observation directions of at least a front viewing angle, a left viewing angle, and a right viewing angle, and a color of a portion exposed outside the housing is different from a color of the housing; and the front viewing angle comprises an angle of viewing from a receiving direction of the reflected laser beam.

15. The laser measurement device according to claim 14, wherein
the exposure outside the housing in the observation directions of at least the front viewing angle, the left viewing angle, and the right viewing angle comprises exposure outside the housing in the observation directions of the front viewing angle, the left viewing angle, the right viewing angle, and a top viewing angle; and/or
the first end comprises a sliding slot extending along the direction of the front viewing angle; the switch key is in movable connection with the sliding slot; the movable connection comprises the moving connection; when the switch key is in the first position, the switch key protrudes outward relative to the housing; and when the switch key is moved from the first position toward an inside of the housing to the second position, the switch key is not exposed outside the housing in the observation directions of the left viewing angle and the right viewing angle; and the switch assembly further comprises:
an elastic piece located in the sliding slot and having two ends respectively connected to the sliding slot and the switch key; and
a self-locking mechanism connected to the first end and the switch key to enable self-locking of the switch key between the first position and the second position.

16. The laser measurement device according to claim 14, wherein the switch key is in rotary connection with the first end; a direction of a rotation axis of the rotary connection is the direction of the front viewing angle; the movable connection comprises the rotary connection; when the switch key is rotated to the first position, a first portion of the switch key is exposed outside the housing at least in the observation directions of the front viewing angle, the left viewing angle, and the right viewing angle, while a second portion of the switch key is located inside the housing; and when the switch key is rotated to the second position, the second portion is exposed outside the housing at least in the observation directions of the front viewing angle, the left viewing angle, and the right viewing angle, while the first portion is located inside the housing, wherein the first portion and the second portion have different colors.

17. The laser measurement device according to claim 16, wherein
the first end comprises a mounting shaft; the switch key comprises a mounting hole that is in rotary connection with the mounting shaft; the mounting shaft comprises a through hole; when the laser measurement device operates, the reflected laser beam passes through the through hole;
an end of the mounting shaft comprises a shaft shoulder that abuts against a side of the switch key; the switch assembly further comprises an axial locating piece that is in fixed connection with the mounting shaft and abuts against another side of the switch key such that the switch key is axially fixed relative to the mounting shaft; and/or
the laser measurement assembly comprises a slope trigger sensor that is mounted inside the housing and disposed opposite the switch key; a trigger structure is disposed on the switch key; when the switch key is in the first position, the trigger structure is opposite to the slope trigger sensor and an enabling signal of the slope trigger sensor is triggered such that the slope measurement is enabled; when the switch key leaves the first position, the trigger structure is moved away from the slope trigger sensor and a disabling signal of the slope trigger sensor is triggered such that the slope measurement is disabled; and
the trigger structure comprises a trigger protrusion that protrudes in a direction toward the slope trigger sensor, or a trigger groove that is recessed in a direction away from the slope trigger sensor.

18. A multi-mode laser distance measurement method, applied to the laser measurement device according to claim 1 and comprising:
activating the second emitting module of the laser measurement device to emit the second emitted laser beam and the receiving module to receive the second reflected laser beam reflected back by the target object;
obtaining a second distance based on the second reflected laser beam;
determining, based on the second reflected laser beam and the second distance, whether operation in a plurality of modes is activated, wherein in the plurality of modes,
the laser measurement device activates the first emitting module to emit the first emitted laser beam and the receiving module to receive the first reflected laser beam reflected back by the target object;
obtaining a first distance based on the first reflected laser beam; and
determining and outputting a target distance based on the first distance and the second distance.

19. The laser distance measurement method according to claim 18, wherein
the target distance is the second distance when the first distance is invalid data;
the target distance is the first distance when the first distance is valid data; and/or
the determining, based on the second reflected laser beam and the second distance, whether operation in a plurality of modes is activated comprises:
activating the operation in the plurality of modes when reflective surface quality for the second reflected laser beam is determined to meet a preset condition and the second distance is less than a distance threshold; or
outputting the second distance as the target distance.

20. A multi-mode laser distance measurement method, applied to the laser measurement device according to claim 1 and comprising:
obtaining a selected mode input by a user, wherein the selected mode is the first mode in which the first emitting module emits the first emitted laser beam or the second mode in which the second emitting module emits the second emitted laser beam;
measuring a target distance between the laser measurement device and the target object based on the selected mode; and
outputting the target distance.
